(19) United States
(12) Patent Application Publication
(10) Pub. No.: US 2022/0195104 A1
(43) Pub. Date: Jun. 23, 2022

(54) SELF-POLYMERIZABLE PHENOLIC RESINS

(71) Applicant: SI GROUP, INC., Schenectady, NY (US)

(72) Inventors: Steele BURGESON, Schenectady, NY (US); Alexandra KRAWICZ, Schenectady, NY (US); Darren C. SEEL, Schenectady, NY (US); John Morgan WHITNEY, Schenectady, NY (US)

(21) Appl. No.: 17/560,151

(22) Filed: Dec. 22, 2021

Related U.S. Application Data
(60) Provisional application No. 63/218,150, filed on Jul. 2, 2021.
(60) Provisional application No. 63/130,069, filed on Dec. 23, 2020.

(51) Int. Cl. C08G 8/30; C08G 8/10; C08F 220/32; C08L 7/00; C08L 9/00; C08J 3/24

(52) U.S. Cl. CPC C08G 8/30; C08G 8/10; C08J 3/24; C08L 7/00; C08L 9/00; C08F 220/325

(57) ABSTRACT

This invention relates to a modified phenolic resin and a process of modifying a phenolic resin by an ethylenically unsaturated carboxylate compound. The ethylenically unsaturated carboxylate compound contains a thermally polymerizable or crosslinkable functional group, and has affinity to or is chemically bonded to the hydroxyl phenyl or the benzene ring of the phenolic resin, thereby introducing the thermally polymerizable or crosslinkable functional group in the phenolic resin. The invention also relates to a rubber composition comprising a rubber component and the modified phenolic resin component wherein the rubber composition does not contain a methylene donor cross-linking agent that decomposes to an aldehyde. The invention also relates to a formaldehyde-free process for preparing a rubber composition comprising mixing a rubber component and the modified phenolic resin component, wherein the process does not emit formaldehyde.

This application claims priority to U.S. Provisional Application No. 63/130,069, filed on Dec. 23, 2020, and U.S. Provisional Application No. 63/218,150, filed on Jul. 2, 2021; both of which are herein incorporated by reference in their entirety.

### FIELD OF THE INVENTION

This invention generally relates to a modified phenolic resin to be used in a rubber composition.

### BACKGROUND

Phenolic resins are commonly used in rubber compounds to improve the properties or performance of the rubber compounds, e.g., to increase the tackiness of the rubber compound; to improve the abrasion resistance of the rubber compound with better stiffness and toughness; to increase the cross-linking matrix of the rubber compound to provide excellent heat, steam, oxidation, and aging resistance; and to improve the adhesion between the rubber matrix and the surface of metal or textile inserts.

Typically, a phenolic resin does not react with the rubber matrix. An interaction between the rubber and the resin can occur where an interpenetrating network is formed between the two components. Methylene donor agents are typically added together with the phenolic resin into a rubber composition and are capable of generating a methylene radical through heating. Upon cure (vulcanization), a rubber-to-rubber crosslink network typically forms. The methylene donor agent can also crosslink the resin to supply a resin-to-resin crosslink network. These two crosslinked networks can interpenetrate each other to provide a reinforcing capability for the rubber composition.

Typical methylene donor agents include, for instance, hexamethylenetetramine (HMTA), di-, tri-, tetra-, penta-, or hexa-N-methylol-melamine; their partially or completely etherified or esterified derivatives, for example hexa(methoxymethyl)melamine (HMMM); or polymers of formaldehyde, such as paraformaldehyde. However, these additional methylene donor agents may produce free formaldehyde during rubber mixing and processing. For instance, in a recent investigation report from ECHA (the European Chemicals Agency), two of the most commonly used methylene donor agents, hexamethylene tetramine (HMTA) and hexamethoxymethyl melamine (HMMM), have been identified as formaldehyde releasers, when used in tyre production as adhesives. See Investigation Report on “Formaldehyde and Formaldehyde Releasers” by the ECHA dated Mar. 15, 2017, accessible via https://echa.europa.eu/documents/10162/13641/annex_xv_report_formaldehyde_en.pdf/.

WO 2015/123781 discusses the need to reduce formaldehyde emissions in lieu of more stringent environmental regulations in recent years to reduce volatile organic compounds (VOCs). The publication focuses on one of the most commonly used methylene donor agents, hexamethylene tetramine (HMTA), and the issue of its decomposition during curing and applications to release environmentally harmful formaldehyde. The publication discloses the replacement of formaldehyde with 5-hydroxymethyl furfural (HMF) during preparation of a phenolic resin and polymerization of hexose-generated HMF with a phenolic compound to produce a phenol-HMF resin.

Therefore, there remains a need in phenolic resin applications to eliminate or replace the conventional crosslinking agent that can release free formaldehyde during rubber mixing and processing, while still providing the necessary interaction between the phenolic resin and rubber matrix, and maintaining the properties and functionalities of the phenolic resin in the rubber composition. This disclosure addresses that need.

### SUMMARY OF THE INVENTION

One aspect of the invention relates to a modified phenolic resin. The modified phenolic resin comprises a phenolic resin modified by an ethylenically unsaturated carboxylate compound having the formula

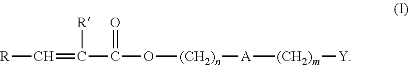

In formula (I), Y is H or a functional group reactive to the hydroxyl phenyl or the benzene ring of the phenolic resin; A is absent, a divalent form of ethene, a divalent form of C₃-C₁₂ cycloalkene, or a divalent form of arene; R and R′ are each independently H or a C₁-C₈ alkyl; and n and m are each independently an integer from 0-6. The ethylenically unsaturated carboxylate compound has affinity to or is chemically bonded to the hydroxyl phenyl or the benzene ring of the phenolic resin through the Y functional group.

Another aspect of the invention relates to a process for preparing a modified phenolic resin. The process comprises reacting a phenolic compound, an aldehyde, and an ethylenically unsaturated carboxylate compound having the formula

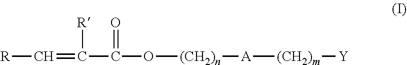

to form the modified phenolic resin. In formula (I), Y is H or a functional group reactive to the hydroxyl phenyl or the benzene ring of the phenolic resin; A is absent, a divalent form of ethene, a divalent form of C₃-C₁₂ cycloalkene, or a divalent form of arene; R and R′ are each independently H or a C₁-C₈ alkyl; and n and m are each independently an integer from 0-6.

Another aspect of the invention relates to a rubber composition. The rubber composition comprises: (a) a rubber component comprising a natural rubber, a synthetic rubber, or a mixture thereof, and (b) a modified phenolic resin component. The modified phenolic resin component comprises a phenolic resin modified by an ethylenically unsaturated carboxylate compound, wherein the ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin. The rubber composition does not contain a methylene donor cross-linking agent that decomposes to an aldehyde.

Another aspect of the invention relates to a formaldehyde-free process for preparing a rubber composition. The formaldehyde-free process comprises mixing (a) a rubber component comprising a natural rubber, a synthetic rubber, or a mixture thereof and (b) a modified phenolic resin component. The modified phenolic resin component comprises: a phenolic resin modified by an ethylenically unsaturated carboxylate compound, wherein the ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin. The process is formaldehyde-free as it does not emit formaldehyde.

### BRIEF DESCRIPTION OF THE DRAWINGS

FIG. 1 shows the mixing viscosity for each rubber sample, characterized by pre-cure strain sweep n* at 100° C. as a function of strain angle. The resins in the rubber samples are described in Table 1.

FIG. 2 shows the curing property for each rubber sample, characterized by torque at 160° C. (for the rubber samples containing blank and control resins) or 150° C. (for the rubber samples containing modified novolac resins) as a function of time. The resins in the rubber samples are described in Table 1.

FIG. 3 shows the tensile stress at 25% strain for each rubber sample. The resins in the rubber samples are described in Table 1.

FIG. 4 shows the tensile elongation at break at ambient conditions for each rubber sample. The resins in the rubber samples are described in Table 1.

FIG. 5 shows the Young's modulus E at ambient conditions for each rubber sample. The resins in the rubber samples are described in Table 1.

FIG. 6 shows the hardness (Shore “A”) measured on a durometer for each rubber sample. The resins in the rubber samples are described in Table 1.

FIGS. 7A-7C show the dynamic properties, measured on a rubber process analyzer (RPA) at 60° C. and 1 Hz after cure, for each rubber sample. FIG. 7A shows the storage modulus (G′) for each rubber sample. FIG. 7B shows the loss modulus (G″) for each rubber sample. FIG. 7C shows the ratio of storage modulus over loss modulus (Tan D) for each rubber sample. The resins in the rubber samples are described in Table 1.

FIG. 8 shows the heat build-up, measured by a flexometer, for each rubber sample. The resins in the rubber samples are described in Table 1.

FIG. 9 shows the mixing viscosity for each rubber sample, characterized by pre-cure strain sweep n* at 100° C. as a function of strain angle. The resins in the rubber samples are described in Table 5.

FIG. 10 shows the curing property for each rubber sample, characterized by torque at 160° C. as a function of time. The resins in the rubber samples are described in Table 5.

FIG. 11 shows the tensile stress at 25% strain for each rubber sample. The resins in the rubber samples are described in Table 5.

FIG. 12 shows the tensile elongation at break at ambient conditions for each rubber sample. The resins in the rubber samples are described in Table 5.

FIG. 13 shows the hardness (Shore “A”) measured on a durometer for each rubber sample. The resins in the rubber samples are described in Table 5.

FIG. 14 show the storage modulus (G′) for each rubber sample. The resins in the rubber samples are described in Table 5.

FIG. 15 shows the mixing viscosity for each rubber sample, characterized by pre-cure strain sweep n* at 100° C. as a function of strain angle. The resins in the rubber samples are described in Table 7.

FIG. 16 shows the curing property for each rubber sample, characterized by torque at 160° C. as a function of time. The resins in the rubber samples are described in Table 7.

FIG. 17 shows the cure time, Tc 90, and scorch time, Ts 5, for each rubber sample. The resins in the rubber samples are described in Table 7.

FIG. 18 shows the tensile stress at 25%, 100%, and 300% strain for each rubber sample. The resins in the rubber samples are described in Table 7.

FIG. 19 shows the tensile elongation at break at ambient conditions for each rubber sample. The resins in the rubber samples are described in Table 7.

FIG. 20 shows the hardness (Shore “A”) measured on a durometer for each rubber sample. The resins in the rubber samples are described in Table 7.

FIG. 21 show the storage modulus (G′) for each rubber sample. The resins in the rubber samples are described in Table 7.

### DETAILED DESCRIPTION OF THE INVENTION

One aspect of the invention relates to a modified phenolic resin. The modified phenolic resin comprises a phenolic resin modified by an ethylenically unsaturated carboxylate compound having the formula

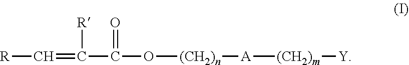

In formula (I), Y is H or a functional group reactive to the hydroxyl phenyl or the benzene ring of the phenolic resin; A is either absent, or alternatively, a divalent form of ethene, a divalent form of C₃-C₁₂ cycloalkene, or a divalent form of arene; R and R′ are each independently H or a C₁-C₈ alkyl; and n and m are each independently an integer from 0-6. The ethylenically unsaturated carboxylate compound has affinity to or is chemically bonded to the hydroxyl phenyl or the benzene ring of the phenolic resin through the Y functional group.

The phenolic resin can be prepared by any phenolic compound known in the art suitable for the condensation reaction with one or more aldehydes.

The phenolic compound may be a monohydric, dihydric, or polyhydric phenol. Suitable monohydric, dihydric, or polyhydric phenols include, but are not limited to: phenol; dihydriephenols such as resorcinol, catechol, hydroquinone; dihydroxybiphenyl such as 4,4′-biphenol, 2,2′-biphenol, and 3,3′-biphenol; alkylidenebisphenols (the alkylidene group can have 1-12 carbon atoms, linear or branched), such as 4,4′-methylenediphenol (bisphenol F), and 4,4′-isopropylidenediphenol (bisphenol A); trihydroxybiphenyls; and thiobisphenols. Exemplary phenolic compounds include phenol or resorcinol.

The benzene ring of the monohydric, dihydric, or polyhydric phenols can be substituted in the ortho, meta, and/or para positions by one or more linear, branched, or cyclic C₁-C₃₀ alkyl, aryl, alkylaryl, arylalkyl, or halogen (F, Cl, or Br). For example, the benzene ring of the phenolic compound can be substituted by C₁-C₂₄ alkyl, C₁-C₁₆ alkyl, C₄-C₁₆ alkyl, or C₄-C₁₂ alkyl (such as tert-C₄-C₁₂ alkyl). Suitable substituents on the benzene ring also include aryl, such as phenyl; C₁-C₃₀ arylalkyl; or C₁-C₃₀ alkylaryl.

In certain embodiments, the phenolic compound is phenol, resorcinol, alkylphenol, or a mixture thereof. The alkyl group of the alkylphenol or alkylresorcinol can contain 1 to 30 carbon atoms, 1 to 24 carbon atoms, 1 to 22 carbon atoms, 1 to 20 carbon atoms, 1 to 16 carbon atoms, 1 to 12 carbon atoms, 1 to 10 carbon atoms, 1 to 8 carbon atoms, 4 to 8 carbon atoms, 1 to 6 carbon atoms, or 1 to 4 carbon atoms. Typical alkylphenols include those having one alkyl group, e.g., at the para position of the phenol; and those having two alkyl groups. Exemplary alkylphenols include para-methylphenol, para-tert-butylphenol (PTBP), para-sec-butylphenol, para-tert-hexylphenol, para-cyclohexylphenol, para-heptylphenol, para-tert-octylphenol (PTOP), para-isooctylphenol, para-decylphenol, para-dodecylphenol (PDDP), para-tetradecyl phenol, para-octadecylphenol, para-nonylphenol, para-pentadecylphenol, and para-cetylphenol.

The phenolic resin can be prepared by a condensation reaction of the phenolic compound with one or more aldehydes using any suitable methods known to one skilled in the art. Any aldehyde known in the art suitable for phenol-aldehyde condensation reaction may be used to form the phenolic resins. Exemplary aldehydes include formaldehyde, methylformcel (i.e., formaldehyde in methanol), butylformcel, acetaldehyde, propionaldehyde, butyraldehyde, crotonaldehyde, valeraldehyde, caproaldehyde, heptaldehyde, benzaldehyde, as well as compounds that decompose to aldehyde such as paraformaldehyde, trioxane, furfural (e.g., furfural or hydroxymethylfurfural), hexamethylenetriamine, aldol, p-hydroxybutyraldehyde, and acetals, and mixtures thereof. A typical aldehyde used is formaldehyde or paraformaldehyde.

The resulting phenolic resin can be a monohydric, dihydric, or polyhydric phenol-aldehyde resin known to one skilled in the art. In certain embodiments, the monohydric, dihydric, or polyhydric phenol of the phenol-aldehyde resin is unsubstituted, or substituted with one or more linear, branched, or cyclic C₁-C₃₀ alkyl, or halogen (F, Cl, or Br). For instance, the phenolic resin may be phenol-aldehyde resin, alkylphenol-aldehyde resin (e.g., cresol-aldehyde resin), resorcinol-aldehyde resin, or combinations thereof.

The phenolic resin may be a novolak resin (the terms “novolak” and “novolac” are interchangeable), or a resole resin. In one embodiment, the phenolic resin is a novolak resin.

Suitable phenolic resins also include those modified by a naturally-derived organic compound containing at least one unsaturated bond. Non-limiting examples of the naturally-derived organic compounds containing at least one unsaturated bond include naturally derived oils, such as tall oils, linseed oil, cashew nut shell liquid, twig oil, unsaturated vegetable oil (such as soybean oil), epoxidized vegetable oil (such as epoxidized soybean oil); cardol, cardanol, rosins, fatty acids, terpenes, and the like.

The phenolic resin is modified by an ethylenically unsaturated carboxylate compound. The ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin.

The term “modified” or “modify” used herein generally refers to any physical or chemical modification of the phenolic resin by one or more ethylenically unsaturated carboxylate compounds. Therefore, the modification not only includes the scenario of chemically bonding the phenolic resin with one or more ethylenically unsaturated carboxylate compounds from a chemical reaction between the two, but also include the scenario where the phenolic resin and one or more ethylenically unsaturated carboxylate compounds are mixed/blended together and form certain interactions such as van der Waals, electrostatic attractions, polar-polar interactions, dispersion forces, or intermolecular hydrogen bonds between the two, because of the affinity of the ethylenically unsaturated carboxylate compound to the hydroxyl phenyl or the benzene ring of the phenolic resin.

By using the term “affinity” is meant to include the scenario where the ethylenically unsaturated carboxylate compound has an interaction with the hydroxyl phenyl or the benzene ring of the phenolic resin other than a chemical bonding.

In one embodiment, the phenolic resin is modified by one or more ethylenically unsaturated carboxylate compounds via mixing the phenolic resin described supra with the one or more ethylenically unsaturated carboxylate compounds described supra.

In one embodiment, the phenolic resin is at least partially chemically modified to form covalent bonds between at least some phenolic resin molecules and one or more ethylenically unsaturated carboxylate compounds described supra resulted from a chemical reaction between the two.

The ethylenically unsaturated carboxylate compound generally contains a first functional group reactive to the hydroxyl phenyl or the benzene ring of the phenolic resin and a second functional group that is a thermally polymerizable or crosslinkable functional group. By reacting its first functional group with and chemically bonding to the hydroxyl phenyl or the benzene ring of the phenolic resin, the ethylenically unsaturated carboxylate compound affixes its thermally polymerizable or crosslinkable functional group into the phenolic resin. Alternatively, when one or more molten phenolic resins are mixed/blended with one or more ethylenically unsaturated carboxylate compounds, described supra, the affinity of the first functional group of the ethylenically unsaturated carboxylate compound to the hydroxyl phenyl or the benzene ring of the phenolic resin may help affix its thermally polymerizable or crosslinkable functional group into the phenolic resin. The resulting modified resin therefore can self-crosslink or self-polymerize upon heating without employing an additional crosslinking agent.

The ethylenically unsaturated carboxylate compound can have the formula

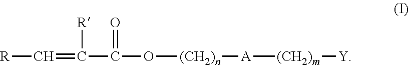

The ethylenically unsaturated carboxylate compound has affinity to or is chemically bonded to the hydroxyl phenyl or the benzene ring of the phenolic resin through the Y functional group.

In formula (I), Y is H or a functional group reactive to the hydroxyl phenyl or the benzene ring of the phenolic resin. For instance, Y can be H, an epoxide group, a formyl group, or a halide group.

A is either absent, or alternatively, a divalent form of ethene, a divalent form of C₃-C₁₂ cycloalkene, or a divalent form of arene. For instance, A may be absent, a divalent form of ethene, or a divalent form of benzene.

R and R′ are each independently H or a C₁-C₈ alkyl. For instance, R and R′ are each independently H or methyl.

Integers n and m are each independently from 0-6. For instance, n and m are each independently 0, 1, or 2.

In some embodiments, A is either absent, or alternatively, a divalent form of ethene, or a divalent form of benzene; R and R′ are each independently H or methyl; and n and m are each independently 0, 1, or 2.

In some embodiments, A is absent, R is H, and m is 0. Y is an epoxide group or a formyl group.

Exemplary ethylenically unsaturated carboxylate compounds can be represented by

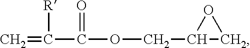

wherein R′ is defined supra. For instance, the ethylenically unsaturated carboxylate compound can be glycidyl methacrylate or glycidyl acrylate.

Exemplary ethylenically unsaturated carboxylate compounds can also be represented

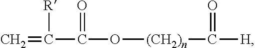

wherein R′ and n are defined supra. In one embodiment, R′ is H or methyl. In one embodiment, n is 0, 1, or 2.

In some embodiments, A is a divalent form of ethene, R is H, and m is 1. Exemplary ethylenically unsaturated carboxylate compounds can be represented by

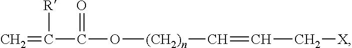

wherein R′ and n are defined supra, and X is a halide group. In one embodiment, R′ is H or methyl. In one embodiment, n is 0, 1, or 2.

In some embodiments, A is a divalent form of arene (such as a divalent form of benzene), R is H, and m is 1. Exemplary ethylenically unsaturated carboxylate compounds can be represented by

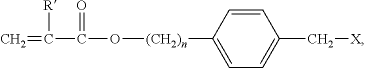

wherein R′ and n are defined supra, and X is a halide group. In one embodiment, R′ is H or methyl. In one embodiment, n is 0, 1, or 2.

The term “halide” or “halogen” as used herein refers to a monovalent halogen radical or atom selected from F, Cl, Br, and I. Exemplary groups are F, Cl, and Br.

The terms “divalent form of ethene,” “divalent form of C₃-C₁₂ cycloalkene,” or “divalent form of arene” refer to a divalent radical that is formed by removal of two hydrogen atoms from an ethane, a C₃-C₁₂ cycloalkene, or an arene, respectively. For instance, in the case of divalent form of ethene, the term refers to a structure of —CH═CH—. For instance, in the case of divalent form of cycloalkene, the term refers to a divalent radical that is formed by removal of a hydrogen atom from each of two different carbon atoms of the cycloalkene ring. By way of an example, divalent form of cyclopentene is formed by removal of a hydrogen atom from each of two different carbon atoms of the cyclopentane ring, and may have a structure of

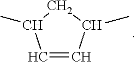

For instance, in the case of a divalent form of arene, the term refers to a divalent radical that is formed by removal of a hydrogen atom from each of two different carbon atoms of the arene ring. By way of an example, a divalent form of benzene is formed by removal of a hydrogen atom from each of two different carbon atoms of the benzene ring, and may have a structure of

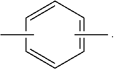

The phenolic resins may be modified by one or more different ethylenically unsaturated carboxylate compounds described supra. For instance, different ethylenically unsaturated carboxylate compounds with different types of functional groups reactive to the hydroxyl phenyl or the benzene ring of the phenolic resin may be used in modifying the phenolic resin.

The modified phenolic resin can be used in the rubber composition as a bonding (adhesive) resin or a reinforcing resin.

A phenolic reinforcing resin is used to increase the dynamic stiffness, surface hardness, toughness, the abrasion resistance, and dynamic modulus of a rubber article. Typically, reinforcing resins are phenol-aldehyde based resins, alkylphenol-aldehyde (e.g., cresol-aldehyde) based resins, or a mixture thereof. These phenolic resins may be modified with a naturally-derived organic compound containing at least one unsaturated bond, as discussed supra, such as a fatty acid, tall oil, or cashew nut shell liquid, and are subjected to a heat treatment.

A phenolic bonding (adhesive) resin is used as an adhesive promotor that can form permanent bonds between the rubber matrix and a non-rubber component in a rubber composition to improve adhesion between the rubber matrix and a non-rubber component such as a mechanical reinforcement (e.g., fabrics, wires, metals, or fibers such as glass fiber inserts), to impart load-bearing properties. Typically, bonding (adhesive) resins are phenol-aldehyde based resins, resorcinol-aldehyde based resins, alkylphenol-aldehyde (e.g., cresol-aldehyde) based resins, or a mixture thereof.

The amount of the ethylenically unsaturated carboxylate compounds in the phenolic resin for modifying phenolic resin depends on the type of the phenolic resins being used, and can range from about 0.1 to about 25 wt %. For a bonding (adhesive) resin, the amount of the ethylenically unsaturated carboxylate compound typically ranges from about 0.1 to about 10 wt %, for instance, from about 0.5 to about 10 wt %, from about 1 to about 10 wt %, or from about 1 to about 8 wt %. For a reinforcing resin, the amount of the ethylenically unsaturated carboxylate compound typically ranges from about 1 to about 25 wt %, for instance, from about 1 to about 20 wt %, from about 3 to about 17 wt %, from about 3 to about 8 wt %, from about 5 to about 8 wt %, or from about 3 to about 5 wt %.

Alternatively, for a bonding (adhesive) resin, the amount of the ethylenically unsaturated carboxylate compound can range from about 0.1 to about 10 wt %, for instance, from about 0.5 to about 10 wt %, from about 0.5 to about 8 wt %, or from about 0.5 to about 5 wt %. For a reinforcing resin, the amount of the ethylenically unsaturated carboxylate compound can range from about 0.5 to about 25 wt %, for instance, from about 0.5 to about 20 wt %, from about 0.5 to about 17 wt %, from about 0.5 to about 8 wt %, or from about 0.5 to about 5 wt %.

As discussed supra, the ethylenically unsaturated carboxylate compound affixes its thermally polymerizable or crosslinkable functional group into the phenolic resin by its affinity or chemical bonding to the phenolic resin. The modified phenolic resin therefore can self-crosslink or self-polymerize upon heating without employing an additional crosslinking agent. This means the modified phenolic resin can be used as a single-component curing system for a rubber formulation that is self-crosslinkable or self-polymerizable by heating (upon cure or vulcanization). It is considered “single-component” as compared to a two-component curing system that contains not only a phenolic resin, but also a crosslinking agent (e.g., a methylene donor agent that is able to generate a methylene radical by heating upon cure (vulcanization)) that is required to crosslink the resin matrix with rubber matrix, when used in a rubber formulation.

Alternatively, the modified phenolic resin can further comprise a crosslinking agent, e.g., a non-methylene donor crosslinking agent. For instance, the non-methylene donor crosslinking agent can be an amine crosslinking agent or a dithiol crosslinking agent. Exemplary amine or dithiol cross-linking agents are melamine, diethylene triamine, m-xylylenediamine, and 1,2-ethanedithiol.

The amount of the non-methylene donor crosslinking agent (e.g., an amine or dithiol cross-linking agent) may generally be present in a stoichiometric amount of the ethylenically unsaturated carboxylate compound, or in excess of the stoichiometric amount of the ethylenically unsaturated carboxylate compound. The term “stoichiometric amount” or “stoichiometric quantity” used herein takes into consideration the molar ratio of the number of reactive sites of the reactant relative to the ethylenically unsaturated carboxylate compound. For instance, if the stoichiometric ratio of the crosslinking agent and the ethylenically unsaturated carboxylate compound is considered 1:1, the stoichiometric amount of the crosslinking agent can be calculated by the equation: M_{CLA}=[(M_{EUCC}/MW_{EUCC})/n]×MW_{CLA}, where M_{CLA}, MW_{CLA}, M_{EUCC}, and MW_{EUCC} are mass and molecular weight of the crosslinking agent and the ethylenically unsaturated carboxylate compound, respectively, and n is the molar ratio of the number of reactive sites of the crosslinking agent relative to the ethylenically unsaturated carboxylate compound. For instance, in the case a phenolic resin modified by glycidyl methacrylate containing a melamine as the additional crosslinking agent, the stoichiometric ratio between glycidyl methacrylate and melamine is considered 1:1, but assuming 3 moles of reactive sites per mole of melamine and 1 mole of reactive site per mole of glycidyl methacrylate. The stoichiometric amount of melamine based on the definition herein can be calculated by Mₘₑₗₐₘᵢₙₑ[(M_{GMA}/MW_{GMA})/3]×MWₘₑₗₐₘᵢₙₑ. Typically, the amount of the non-methylene donor crosslinking agent (e.g., an amine or dithiol cross-linking agent) added is in excess of the stoichiometric amount of the ethylenically unsaturated carboxylate compound, with the excess in the range of from about 0.1% to about 30%, from about 1% to about 20%, or from about 10 to about 15%.

### Process for Preparing the Modified Phenolic Resin

Another aspect of the invention relates to a process for preparing a modified phenolic resin. The process comprises reacting a phenolic compound, an aldehyde, and an ethylenically unsaturated carboxylate compound to form the modified phenolic resin. The ethylenically unsaturated carboxylate compound can have the formula

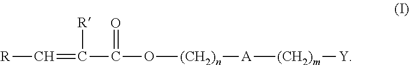

In formula (I), Y is H or a functional group reactive to the hydroxyl phenyl or the benzene ring of the phenolic resin; A is either absent, or alternatively, a divalent form of ethene, a divalent form of C₃-C₁₂ cycloalkene, or a divalent form of arene; R and R′ are each independently H or a C₁-C₈ alkyl; and n and m are each independently an integer from 0-6.

All above descriptions and all embodiments regarding the phenolic resin and the ethylenically unsaturated carboxylate compound discussed above in the aspect of the invention relating to the modified phenolic resin are applicable to this aspect of the invention.

The reacting step may be carried out by reacting the phenolic compound and the aldehyde to form a phenolic resin, and modifying the phenolic resin by mixing the phenolic resin with the ethylenically unsaturated carboxylate compound, wherein the ethylenically unsaturated carboxylate compound has affinity to the hydroxyl phenyl or the benzene ring of the phenolic resin through the Y functional group, thereby introducing the thermally polymerizable or crosslinkable functional group in the phenolic resin.

The reacting step may comprise reacting the phenolic compound and the aldehyde to form a phenolic resin, and modifying the phenolic resin by reacting (e.g., at least partially chemically bonding) the ethylenically unsaturated carboxylate compound to the hydroxyl phenyl or the benzene ring of the phenolic resin, through the first functional group of the ethylenically unsaturated carboxylate compound that is reactive to the hydroxyl phenyl or the benzene ring of the phenolic resin (in the case of formula (I), through the Y functional group).

The following schemes are illustrative of possible reactions between exemplary ethylenically unsaturated carboxylate compounds and the phenolic resins.

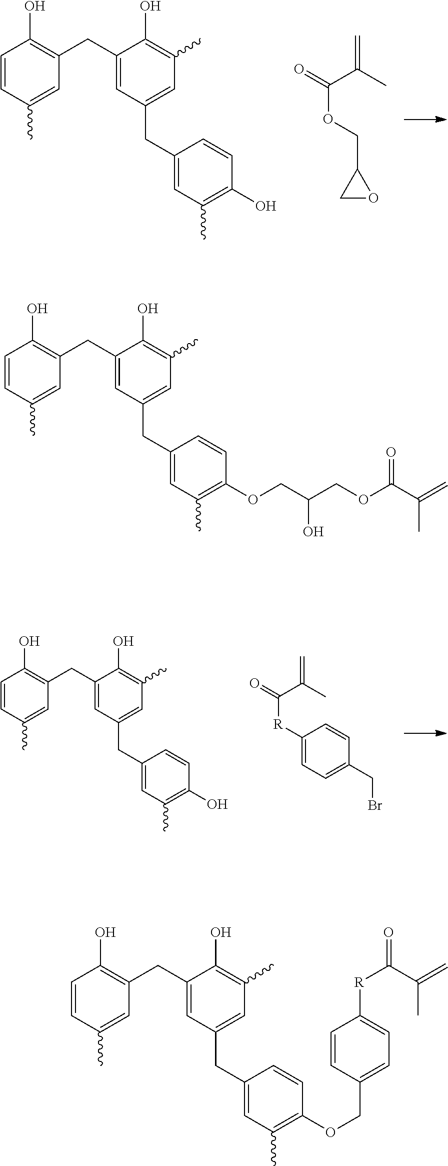

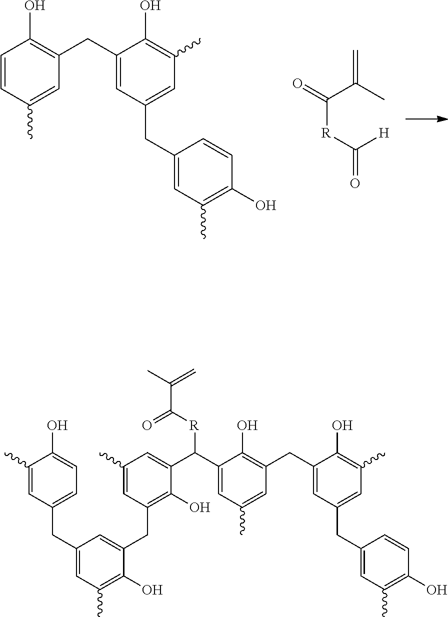

In certain embodiments, the process for preparing a modified phenolic resin comprises mixing and/or reacting one or more phenolic resins with one or more ethylenically unsaturated carboxylate compounds.

In one embodiment, in the modifying step, the phenolic resin is at least partially chemically modified to form covalent bonds between at least some phenolic resin molecules and one or more ethylenically unsaturated carboxylate compounds, described supra, resulting from a chemical reaction between the two.

The modifying step (e.g., mixing and/or reaction between the phenolic resin and the ethylenically unsaturated carboxylate compound) is typically carried out in the presence of a base catalyst. Suitable base catalysts include, but are not limited to an alkali hydroxide or an amine. Exemplary alkali hydroxides are sodium hydroxide, potassium hydroxide, lithium hydroxide, rubidium hydroxide, and caesium hydroxide. Exemplary amines are tertiary amines such as trimethylamine and trimethylamine.

Alternatively, the modifying step (e.g., mixing and/or reaction between the phenolic resin and the ethylenically unsaturated carboxylate compound) can be carried out without a catalyst, particularly when the ethylenically unsaturated carboxylate compound is mixed/blended with a molten form of the phenolic resin.

The modifying step (e.g., mixing and/or reaction between the phenolic resin and the ethylenically unsaturated carboxylate compound) can be carried out in the presence of an organic solvent, for instance, an alcohol (methanol, ethanol, or propanol), ketone (e.g., acetone or methyl ethyl ketone), or combinations thereof.

Alternatively, the modifying step (e.g., mixing and/or reaction between the phenolic resin and the ethylenically unsaturated carboxylate compound) can be carried out under solventless conditions, particularly when the ethylenically unsaturated carboxylate compound is mixed/blended with a molten form of the phenolic resin.

The modifying step (e.g., mixing and/or reaction between the phenolic resin and the ethylenically unsaturated carboxylate compound) is typically carried out at an elevated temperature ranging from about 30° C. to about 100° C., from about 50° C. to about 70° C., or from about 50° C. to about 60° C., when a solvent is present in the during the modifying step.

When the modifying step (e.g., mixing and/or reaction between the phenolic resin and the ethylenically unsaturated carboxylate compound) is carried out in the absence of a solvent, the phenolic resin is typically used in a molten form, and the modifying step is typically carried out at a temperature ranging from about 80° C. to about 160° C., from about 100° C. to about 140° C., from about 110° C. to about 130° C., or from about 110° C. to about 120° C.

The mixing and/or reaction shall be carried out under a relatively mild temperature to not exceed 135° C., in order to avoid the pre-mature self-polymerization or self-crosslinking of the modified phenolic resin.

The process for preparing a modified phenolic resin may further comprise adding one or more additional phenolic resins, which are not modified by the ethylenically unsaturated carboxylate compounds, to the modified phenolic resin prepared by the above modifying step. Suitable additional phenolic resins include those discussed above in the aspect of the invention relating to the modified phenolic resin.

### Rubber Composition and Rubber Product

When the phenolic resins are added in a rubber formulation, an additional crosslinking agent (e.g., a methylene donor) is typically needed to crosslink the resin matrix and rubber matrix at the curing stage.

The inventors have unexpectedly discovered that the use of a particular type of ethylenically unsaturated carboxylate compound to modify a phenolic resin can result in a modified phenolic resin that can be used as a single-component curing system for a rubber formulation. The novel modified phenolic resin is self-crosslinkable or self-polymerizable by heating (upon cure or vulcanization), thus eliminating the need to use a conventional crosslinking agent that can release free formaldehyde during rubber mixing and processing processes; yet the resin still provides the comparable crosslinking network and comparable or even improved tensile strength and/or stiffness properties.

Accordingly, one aspect of the invention relates to a rubber composition. The rubber composition comprises: (a) a rubber component comprising a natural rubber, a synthetic rubber, or a mixture thereof, and (b) a modified phenolic resin component. The modified phenolic resin component comprises a phenolic resin modified by an ethylenically unsaturated carboxylate compound, wherein the ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin. The rubber composition does not contain a methylene donor cross-linking agent that decomposes to an aldehyde.

In some embodiments, the ethylenically unsaturated carboxylate compound has the formula

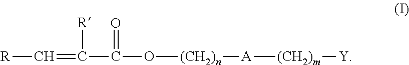

In formula (I), Y is H or a functional group reactive to the hydroxyl phenyl or the benzene ring of the phenolic resin; A is either absent, or alternatively, a divalent form of ethene, a divalent form of C₃-C₁₂ cycloalkene, or a divalent form of arene; R and R′ are each independently H or a C₁-C₈ alkyl; and n and m are each independently an integer from 0-6. The ethylenically unsaturated carboxylate compound has affinity to or is chemically bonded to the hydroxyl phenyl or the benzene ring of the phenolic resin through the Y functional group.

All above descriptions and all embodiments regarding the phenolic resin, the ethylenically unsaturated carboxylate compound, and the process and reaction conditions for preparing the modified phenolic resin discussed above in the aspects of the invention relating to the modified phenolic resin and the process for preparing the modified phenolic resin are applicable to this aspect of the invention.

In some embodiments, in the modified phenolic resin component, the ethylenically unsaturated carboxylate compound is

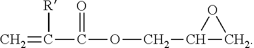

In one embodiment, the ethylenically unsaturated carboxylate compound is glycidyl methacrylate or glycidyl acrylate.

In some embodiments, in the modified phenolic resin component, the ethylenically unsaturated carboxylate compound is represented by one of the following formulas:

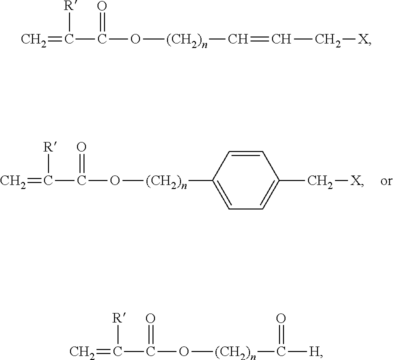

wherein n is 0, 1, or 2, and X is a halide.

In some embodiments, in the modified phenolic resin component, the phenolic resin is a monohydric- or dihydric-phenolic-aldehyde resin, optionally modified by a naturally-derived organic compound containing at least one unsaturated bond. In some embodiments, the phenolic resin is a phenol-aldehyde resin, alkylphenol-aldehyde resin, resorcinol-aldehyde resin, or combinations thereof.

In some embodiments, in the modified phenolic resin component, the amount of the ethylenically unsaturated carboxylate compound ranges from about 0.1 wt % to about 25 wt %, based on the amount of the phenolic resin; for instance, from about 0.1 to about 10 wt %, from about 0.5 to about 10 wt %, from about 1 to about 10 wt %, or from about 1 to about 8 wt %, based on the amount of the phenolic resin, for a bonding (adhesive) resin; or from about 1 to about 20 wt %, from about 3 to about 17 wt %, from about 3 to about 8 wt % from about 5 to about 8 wt %, or from about 3 to about 5 wt %, based on the amount of the phenolic resin, for a reinforcing resin.

In some alternative embodiments, in the modified phenolic resin component, the amount of the ethylenically unsaturated carboxylate compound ranges from about 0.1 wt % to about 25 wt %, based on the amount of the phenolic resin; for instance, from about 0.1 to about 10 wt %, from about 0.5 to about 10 wt %, from about 0.5 to about 8 wt %, or from about 0.5 to about 5 wt %, based on the amount of the phenolic resin, for a bonding (adhesive) resin; or from about 0.5 to about 25 wt %, from about 0.5 to about 20 wt %, from about 0.5 to about 17 wt %, from about 0.5 to about 8 wt %, or from about 0.5 to about 5 wt %, based on the amount of the phenolic resin, for a reinforcing resin.

In some embodiments, the rubber composition further comprises a crosslinking agent, e.g., a non-methylene donor crosslinking agent. In some embodiments, the non-methylene donor crosslinking agent is an amine crosslinking agent or a dithiol crosslinking agent. Exemplary amine or dithiol cross-linking agents are melamine, diethylene triamine, m-xylylenediamine, and 1,2-ethanedithiol.

In some embodiments, the non-methylene donor crosslinking agent (e.g., an amine or dithiol cross-linking agent) is added in a stoichiometric amount of the ethylenically unsaturated carboxylate compound, or in excess of the stoichiometric amount of the ethylenically unsaturated carboxylate compound. In one embodiment, the amount of an amine or dithiol cross-linking agent added is added in excess of the stoichiometric amount of the ethylenically unsaturated carboxylate compound, with the excess in the range of from about 0.1% to about 30%, from about 1% to about 20%, or from about 10 to about 15%.

The amount of the modified phenolic resin component contained in the rubber composition typically ranges from about 0.5 to about 50 parts per 100 parts rubber by weight, from about 5 to about 50 parts per 100 parts rubber by weight, or from about 5 to about 15 parts per 100 parts rubber by weight.

These rubber compositions include a rubber component, such as a natural rubber, a synthetic rubber, or a mixture thereof. For instance, the rubber composition may be a natural rubber composition. Alternatively, the rubber composition can be a synthetic rubber composition. Representative synthetic rubbery polymers include diene-based synthetic rubbers, such as homopolymers of conjugated diene monomers, and copolymers and terpolymers of the conjugated diene monomers with monovinyl aromatic monomers and trienes. Exemplary diene-based compounds include, but are not limited to, polyisoprene such as 1,4-cis-polyisoprene and 3,4-polyisoprene; neoprene; polystyrene; polybutadiene; 1,2-vinyl-polybutadiene; butadiene-isoprene copolymer; butadiene-isoprene-styrene terpolymer; isoprene-styrene copolymer; styrene/isoprene/butadiene copolymers; styrene/isoprene copolymers; emulsion styrene-butadiene copolymers; solution styrene/butadiene copolymers; butyl rubber such as isobutylene rubber; ethylene/propylene copolymers such as ethylene propylene diene monomer (EPDM); and blends thereof. A rubber component, having a branched structure formed by use of a polyfunctional modifier such as tin tetrachloride, or a multifunctional monomer such as divinyl benzene, may also be used. Additional suitable rubber compounds include nitrile rubber, acrylonitrile-butadiene rubber (NBR), silicone rubber, the fluoroelastomers, ethylene acrylic rubber, ethylene vinyl acetate copolymer (EVA), epichlorohydrin rubbers, chlorinated polyethylene rubbers such as chloroprene rubbers, chlorosulfonated polyethylene rubbers, hydrogenated nitrile rubbers, hydrogenated isoprene-isobutylene rubbers, tetrafluoroethylene-propylene rubbers, and blends thereof.

The rubber composition can also be a blend of natural rubber with a synthetic rubber, a blend of different synthetic rubbers, or a blend of natural rubber with different synthetic rubbers. For instance, the rubber composition can be a natural rubber/polybutadiene rubber blend, a styrene butadiene rubber-based blend, such as a styrene butadiene rubber/natural rubber blend, or a styrene butadiene rubber/butadiene rubber blend. When using a blend of rubber compounds, the blend ratio between different natural or synthetic rubbers can be flexible, depending on the properties desired for the rubber blend composition.

In some embodiments, the rubber composition does not contain a conventional methylene donor, such as hexamethylenetetramine (HMTA) or hexa(methoxymethyl)melamine (HMMM). In some embodiments, the rubber composition does not contain an aldehyde or compounds that decompose to an aldehyde.

The rubber composition may comprise additional materials, such as one or more sulfur curing (vulcanizing) agents, one or more sulfur curing (vulcanizing) accelerators, one or more other rubber additives, one or more reinforcing materials, and one or more oils. As known to one skilled in the art, these additional materials are selected and commonly used in conventional amounts.

Suitable sulfur curing (vulcanizing) agents include, but are not limited to, Rubbermakers' soluble sulfur; sulfur donating vulcanizing agents, such as an amine disulfide, polymeric polysulfide or sulfur olefin adducts; and insoluble polymeric sulfur. For instance, the sulfur curing agent may be soluble sulfur or a mixture of soluble and insoluble polymeric sulfur. The sulfur curing agents can be used in an amount ranging from about 0.1 to about 15 phr, alternatively from about 1.0 to about 10 phr, from about 1.5 to about 7.5 phr, or from about 1.5 to about 5 phr.

Suitable sulfur curing (vulcanizing) accelerators include, but are not limited to, a thiazole such as 2-mercaptobenzothiazole (MBT), 2-2′-dithiobis(benzothiazole) (MBTS), zinc-2-mercaptobenzothiazole (ZMBT); a thiophosphate such as zinc-O,O-di-N-phosphorodithioate (ZBDP); a sulfenamide such as N-cyclohexyl-2-benzothiazole sulfenamide (CBS), N-tert-butyl-2-benzothiazole sulfenamide (TBBS), 2-(4-morpholinothio)-benzothiazole (MBS), N,N′-dicyclohexyl-2-benzothiazole sulfenamide (DCBS); a thiourea such as ethylene thiourea (ETU), di-pentamethylene thiourea (DPTU), dibutyl thiourea (DBTU); a thiuram such as tetramethylthiuram monosulfide (TMTM), tetramethylthiuram disulfide (TMTD), dipentamethylenethiuram tetrasulfide (DPTT), tetrabenzylthiuram disulfide (TBzTD); a dithiocarbamate such as zinc dimethyldithiocarbamate (ZDMC), zinc diethyldithiocarbamate (ZDEC), zinc dibutyldithiocarbamate (ZDBC), zinc dibenzyldithiocarbamate (ZBEC); and a xanthate such as zinc-isopropyl (ZIX). Additional examples for suitable sulfur curing accelerators may be found in U.S. Pat. No. 4,861,842, which is incorporated herein by reference in its entirety, to the extent not inconsistent with the subject matter of this disclosure. The sulfur curing accelerators can be used in an amount ranging from about 0.1 to about 25 phr, alternatively from about 1.0 to about 10 phr, from about 1.5 to about 7.5 phr, or from about 1.5 to about 5 phr.

Suitable other rubber additives include, for instance, zinc oxides, carbon black, silica, waxes, antioxidant, antiozonants, peptizing agents, fatty acids, stearates, curing agents, activators, retarders (e.g., scorch retarders), a cobalt source, adhesion promoters, plasticizers, pigments, additional fillers, and mixtures thereof.

Suitable reinforcing materials include, for instance, nylon, rayon, polyester, aramid, glass, steel (brass, zinc or bronze plated), or other organic and inorganic compositions. These reinforcing materials may be in the form of, for instance, filaments, fibers, cords or fabrics.

Suitable oils include, for instance, mineral oils and naturally derived oils. Examples of naturally derived oils include tall oil, linseed oil, cashew nut shell liquid, soybean oil, and/or twig oil. Commercial examples of tall oil include, e.g., SYLFAT™ FA-1 (Arizona Chemicals) and PAMAK 4™ (Hercules Inc.). The oils may be contained in the rubber composition, relative to the total weight of rubber component, in amounts less than about 5 wt %, for instance, less than about 2 wt %, less than about 1 wt %, less than about 0.6 wt %, less than about 0.4 wt 00 less than about 0.3 wt %, or less than about 0.2 wt %. The presence of an oil in the rubber composition may aid in providing improved flexibility of the rubber composition after vulcanization.

The rubber composition prepared with the modified phenolic resin, yet without using the conventional methylene donor cross-linking agent discussed supra, has comparable or enhanced physical and dynamic properties such as comparable or improved tensile strength, elongation, stiffness, or tensile stiffness upon curing.

In some embodiments, the elongation of the rubber composition containing the modified phenolic resin, characterized by % strain at break at ambient conditions, increases by about 5% or more (or about 7% or more). This improvement in elongation can be observed while the resin, at the same time, maintains a comparable tensile strength at ambient conditions, as compared to a rubber composition containing the same phenolic resin (but not modified by the ethylenically unsaturated carboxylate compound) and a methylene donor cross-linking agent (e.g., as compared to a conventional rubber composition containing hexa(methoxymethyl)melamine (HMMM)).

In some embodiments, the tensile stiffness of the rubber composition containing the modified phenolic resin, characterized by Young's modulus E at ambient conditions, increases by about 7% or more (or about 10% or more), as compared to a rubber composition containing the same phenolic resin (but not modified by the ethylenically unsaturated carboxylate compound) and a methylene donor cross-linking agent (e.g., as compared to a conventional rubber composition containing hexa(methoxymethyl)melamine (HMMM)).

In some embodiments, the stiffness of the rubber composition containing the modified phenolic resin, characterized by storage modulus G′ at 60° C. and 1 Hz, increases by 10% or more (or about 13% or more), as compared to a rubber composition containing the same phenolic resin (but not modified by the ethylenically unsaturated carboxylate compound) and a methylene donor cross-linking agent (e.g., as compared to a conventional rubber composition containing hexa(methoxymethyl)melamine (HMMM)).

In certain embodiments, the rubber composition is a reinforced rubber composition. The modified phenolic resin is used in the rubber composition as a reinforcing resin. The reinforcing capability of the reinforced rubber composition is maintained or improved compared to a rubber composition containing the same phenolic resin (but not modified by the ethylenically unsaturated carboxylate compound) and a methylene donor cross-linking agent (e.g., as compared to a conventional rubber composition containing hexa(methoxymethyl)melamine (HMMM).

In certain embodiments, the modified phenolic resin is used in the rubber composition as a bonding (adhesive) resin, for instance, to bond the rubber matrix and the surface of the metal or textile inserts (e.g., bonding tire rubber to under-ply tire cord). The bonding (adhesive) properties of the rubber composition are maintained or improved compared to a rubber composition containing the same phenolic resin (but not modified by the ethylenically unsaturated carboxylate compound) and a methylene donor cross-linking agent (e.g., as compared to a conventional rubber composition containing hexa(methoxymethyl)melamine (HMMM).

The rubber compositions according to the invention are curable (vulcanizable) rubber compositions and can be cured (vulcanized) by using mixing equipment and procedures known in the art, such as mixing the various curable (vulcanizable) polymer(s) with the modified phenolic resin, and commonly used additive materials such as, but not limited to, curing agents, activators, retarders and accelerators; processing additives, such as oils; plasticizers; pigments; additional fillers; fatty acid; stearates; adhesive promoters; zinc oxide; waxes; antioxidants; antiozonants; peptizing agents; and the like. As known to those skilled in the art, the additives mentioned above are selected and commonly used in conventional amounts.

One aspect of the invention also relates to a wide variety of rubber products formed from the rubber composition described supra. Such rubber products can be built, shaped, molded and cured by various methods known to one skilled in the art. All above descriptions and all embodiments in the context of the rubber composition are applicable to this aspect of the invention relating to such rubber products.

Suitable rubber products include those rubber parts or articles that are subject to dynamic motion, for instance, tires or tire components, which include but are not limited to, sidewall, shoulder, tread (or treadstock, subtread), bead, ply, belt, rim strip, inner liner, chafer, carcass ply, body ply skim, wire skim coat, bead filler, overlay compound for tire, or any tire part that can be made of rubber. A more extensive discussion of various tire parts/components can be found in U.S. Pat. Nos. 3,542,108; 3,648,748; and 5,580,919, which are incorporated herein by reference in their entirety, to the extent not inconsistent with the subject matter of this disclosure. Suitable rubber products also include hoses, power belts, conveyor belts, and printing rolls. One embodiment of the invention relates to a tire or tire component containing the rubber component and the modified phenolic resin.

### Process of Preparing Rubber Composition

Another aspect of the invention relates to a formaldehyde-free process for preparing a rubber composition. The formaldehyde-free process comprises mixing (a) a rubber component comprising a natural rubber, a synthetic rubber, or a mixture thereof and (b) a modified phenolic resin component. The modified phenolic resin component comprises: a phenolic resin modified by an ethylenically unsaturated carboxylate compound, wherein the ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin. The process is formaldehyde-free as it does not emit formaldehyde.

In some embodiments, the ethylenically unsaturated carboxylate compound has the formula

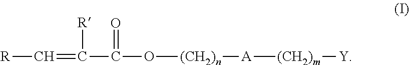

In formula (I), Y is H or a functional group reactive to the hydroxyl phenyl or the benzene ring of the phenolic resin; A is either absent, or alternatively, a divalent form of ethene, a divalent form of C₃-C₁₂ cycloalkene, or a divalent form of arene; R and R′ are each independently H or a C₁-C₈ alkyl; and n and m are each independently an integer from 0-6. The ethylenically unsaturated carboxylate compound has affinity to or is chemically bonded to the hydroxyl phenyl or the benzene ring of the phenolic resin through the Y functional group.

All above descriptions and all embodiments regarding the phenolic resin, the ethylenically unsaturated carboxylate compound, the process and reaction conditions for preparing the modified phenolic resin, and the rubber composition and rubber product discussed above in the aspects of the invention relating to the modified phenolic resin, the process for preparing the modified phenolic resin, the rubber composition, and the rubber product are applicable to this aspect of the invention.

The mixing of the modified phenolic resin component (b) with the rubber component (a) can be performed by various techniques known in the rubber industry. For instance, the modified phenolic resin can be used in the form of viscous solutions or, when dehydrated, brittle resins with varying softening points capable of liquefying upon heating. When used as a solution, liquid, or molten form, the modified phenolic resin component may be mixed into the rubber composition. When used as a solid, the modified phenolic resin component may be mixed with the rubber component using conventional mixing techniques such as internal batch or BANBURY™ mixers. Other types of mixing techniques and systems known to those of skill in the art may also be used.

In some embodiments, the mixing step is carried out at a mixing temperature ranging from about 60° C. to about 140° C., or about 80° C. to about 110° C.

The process may further comprise curing (vulcanizing) the rubber composition in the absence or presence of a curing agent such as a sulfur curing (vulcanizing) agent. A general disclosure of suitable vulcanizing agents, such as sulfur or peroxide-based curing agents, can be found in Kirk-Othmer, Encyclopedia of Chemical Technology (3rd ed., Wiley Interscience, N.Y. 1982), vol. 20, pp. 365-468, particularly Vulcanization Agents and Auxiliary Materials, pp. 390-402, or Vulcanization by A. Y. Coran, Encyclopedia of Polymer Science and Engineering (2^{nd} ed., John Wiley & Sons, Inc., 1989), both of which are incorporated herein by reference, to the extent not inconsistent with the subject matter of this disclosure. Curing agents can be used alone or in combination. Suitable sulfur curing agents and the amounts used also include those discussed supra in the context of the rubber composition.

The curing (vulcanizing) of the rubber composition occurs at a curing temperature sufficient to induce polymerization or crosslinking of the modified phenolic resin. In some embodiments, the modified phenolic resin component is used as a single-component curing system, and wherein the curing is carried out at a curing temperature sufficient to induce self-polymerizing or self-crosslinking of the modified phenolic resin. In some embodiments, the process does not contain adding a conventional methylene donor, such as hexamethylenetetramine (HMTA) or hexa(methoxymethyl)melamine (HMMM). In some embodiments, the process does not contain adding an aldehyde or compounds that decompose to an aldehyde.

In some embodiments, the curing temperature ranges from about 150° C. to about 160° C. A better curing for the rubber composition containing the modified phenolic resin occurs at a curing temperature that is about 10° C. lower than a typical curing temperature for a rubber composition containing the same phenolic resin (but not modified by the ethylenically unsaturated carboxylate compound) and a methylene donor cross-linking agent that decomposes to an aldehyde (e.g., a conventional rubber composition containing hexa(methoxymethyl)melamine (HMMM)).

The process may further comprise adding additional materials, such as one or more sulfur curing (vulcanizing) agents, one or more sulfur curing (vulcanizing) accelerators, one or more other rubber additives, one or more reinforcing materials, and one or more oils to the rubber composition. All above descriptions and all embodiments regarding these additional materials used in the rubber composition discussed above in the aspect of the invention relating to the rubber composition are applicable to these aspects of the invention relating to a process for preparing a rubber composition.

In certain embodiments, the process further comprises adding a sulfur curing (vulcanizing) accelerator to the rubber composition. Suitable sulfur curing accelerators and the amounts used are the same as described supra in the context of the rubber composition.

In certain embodiments, the process further comprises adding a sulfur curing (vulcanizing) agent to the rubber composition. Suitable sulfur curing (vulcanizing) agents and the amounts used are the same as described supra in the context of the rubber composition.

In certain embodiments, the process further comprises adding one or more reinforcing materials to the rubber composition. Suitable reinforcing materials and the amounts used are the same as described supra in the context of the rubber composition.

In certain embodiments, the process further comprises adding a crosslinking agent, e.g., a non-methylene donor crosslinking agent, to the rubber composition. Suitable non-methylene donor crosslinking agents and the amounts used are the same as described supra in the context of the rubber composition.

The process employing the modified phenolic resin, yet without using the conventional methylene donor cross-linking agent discussed supra, has comparable or enhanced mixing and processing properties. For instance, the mixing viscosity, characterized by pre-cure strain at 100° C., is reduced by at least 10% (or at least 13%), as compared to a process for preparing a rubber composition employing the same phenolic resin (but not modified by the ethylenically unsaturated carboxylate compound) and with using a methylene donor cross-linking agent that decomposes to an aldehyde (e.g., as compared to a conventional process for preparing a rubber composition using hexa(methoxymethyl)melamine (HMMM)).

The process can further comprise forming a rubber product from the rubber composition according to ordinary rubber manufacturing techniques. The final rubber products can also be fabricated by using standard rubber curing techniques. For further explanation of rubber compounding and the additives conventionally employed, one can refer to The Compounding and Vulcanization of Rubber, by Stevens in Rubber Technology, Second Edition (1973 Van Nostrand Reibold Company), which is incorporated herein by reference in its entirety, to the extent not inconsistent with the subject matter of this disclosure.

The final rubber product resulted from the process include those discussed supra in the context of the rubber products.

### Examples

The following examples are given as particular embodiments of the invention and to demonstrate the practice and advantages thereof. It is to be understood that the examples are given by way of illustration and are not intended to limit the specification or the claims that follow in any manner.

### Example 1A: Synthesis of an Exemplary Modified Phenolic Resin with a Solvent

The reaction occurred in a round bottom flask equipped with a mechanical agitator, condenser, thermocouple, addition funnel, heating mantle and a J-Kem temperature control box. Alternatively, the reaction was run in a vessel with a drop out valve on the bottom. A phenol-formaldehyde resin (e.g., SI Group HRJ-12952, 490 g) was added gradually into the round bottom flask filled with a methyl ethyl ketone (540 g, 7.5 mol) solvent, while heating gently and stirring vigorously to prevent clumping. Alternatively, an alcohol (such as methanol) was used as the solvent. A solution of 48 wt % of resin in solvent was prepared. The resin was stirred at 50-60° C. until fully dissolved.

Then, 50% sodium hydroxide solution (8.5 g, 0.11 mol) was dripped into the round bottom flask from an addition funnel. The resin and catalyst solution changed color to dark brown and were stirred for 1 hour to equilibrate at 60° C. Next, glycidyl methacrylate (15.15 g, 0.11 mol) was loaded into a clean addition funnel and the reagent was dripped in over 55 minutes at a rate of 0.3 g per minute. The starting materials were reacted for a minimum of 2 hours up to 2.5 hours. This reaction time was previously determined by following the reaction progress with gas chromatography and Fourier-transform infrared spectroscopy (FTIR). The sodium hydroxide was neutralized by adding water (468 g, 26 mol) and sulfuric acid (5.2 g, 0.05 mol) dropwise. Then, stirring was turned off and the contents were cooled to room temperature. Phases were left to separate in the round bottom flask, and subsequently the bottom aqueous phase was aspirated. Alternatively, phase separation was achieved by transferring the contents to a separatory funnel, leaving to separate, and draining the bottom layer. The pH of the aqueous phase was tested with a pH test strip and adjusted to pH=7.

Once phases were separated, the organic portion was returned to the original reaction vessel (e.g., round bottom flask). The solvent was removed via vacuum distillation. During the distillation, the temperature was increased gradually to a preset 95° C., to keep the resin molten while the solvent was being removed. Care was taken not to exceed 100-130° C. and not to induce the self-polymerization of the methacrylates. Finally, the molten resin was poured onto a metal pan and allowed to cool. A typical yield was 94%.

### Example 1B: Synthesis of an Exemplary Modified Phenolic Resin without a Solvent

To a 4-neck 5 L round bottom flask equipped with a Dean Stark, agitator, thermocouple, and condenser, 1009.2 g (10.7 mol) of phenol was added at 95° C. Next, 5.1 g (0.06 mol) of oxalic acid was added and the mixture was agitated at 95° C. for 30 minutes. Then, 444.1 g (7.4 mol) of 50% aqueous formaldehyde was added over a period of 2.5 hours. After all formaldehyde was added, the resin was allowed to stir for 30 minutes. Atmospheric distillation up to 140° C. was carried out, immediately followed by vacuum distillation. The resin was held at 175° C. and 16 mbar for 2 hours. The total distillate collected for these steps was 493.2 g. After distillation was complete, the resin was cooled to 120° C. while still under vacuum. When the temperature of the resin was 130° C., the vacuum was removed and a condenser with a nitrogen line was attached to the reactor. The amount of resin in the reactor was 936.7 g.

Next, 18.2 g (0.13 mol) glycidyl methacrylate was added dropwise into the molten resin over 1 hour. The resin was agitated at 120° C. for 30 minutes at which point the resin was removed from the reactor and allowed to cool. The resin was obtained in 97.3% yield with a final softening point of 102.7° C.

### Example 1C: Synthesis of an Exemplary Modified Phenolic Resin without a Solvent

To a 4-neck 2 L round bottom flask equipped with a Dean Stark, agitator, thermocouple, and condenser, 490.0 g of a phenol-formaldehyde resin (e.g., SI Group HRJ-12952) was added. Over 2.5 hours, the resin was melted. To the molten resin at 120° C., 15.2 g (0.11 mol) glycidyl methacrylate was added dropwise via addition funnel for 30 minutes. The resin was further agitated at 120° C. for 30 minutes at which point the resin was removed from the reactor and allowed to cool. The resin was obtained in 98.9% yield with a final softening point of 107.6° C.

### Example 2A: Rubber Formulation Using an Exemplary Modified Phenolic Resin

In this example, the phenolic resins modified by the ethylenically unsaturated carboxylate compound were prepared according to Example 1A, with varying the amounts of glycidyl methacrylate based on the amount of the phenolic resin.

### Rubber Mixing

A rubber compound formulated for the shoulder of a tire was used for performance application testing of the rubber containing the functionalized glycidyl methacrylate phenol-formaldehyde resins. The tire shoulder, located between the tread and sidewall, requires reinforcement for stiffness and a lowered hysteresis would aid in improving the wear on the tire and rolling resistance of the vehicle.

The following samples listed in Table 1 were tested for the performance application testing. A commercially available reinforcing resin (SI Group HRJ-12952) was used as the phenol novolac resin in the Control sample given in Table 1. Glycidyl methacrylate was used for modifying phenol novolac resins, according to Example 1A, with the amounts of glycidyl methacrylate used in Example 1A at 5 wt %, 7.5 wt %, and 17 wt %, respectively, based on the amount of the phenolic resin. Modified phenolic resins 1 to 3 do not contain a crosslinker, whereas modified phenolic resins 1-M to 3-M correspond to modified phenolic resins 1 to 3 respectively, plus a melamine crosslinker.

TABLE 1
Shoulder formulation sample descriptions

| Sample | Description |
|---|---|
| Blank | Sample prepared without a phenolic novolac resin, and without a crosslinker. |
| Control | Sample prepared including a phenolic novolac resin (SI Group HRJ-12952) |
| | and HMMM crosslinker. |
| Modified phenolic | Sample prepared including a 5 wt % glycidyl methacrylate modified |
| resin 1 | phenolic novolac resin, but no crosslinker. |
| Modified phenolic | Sample prepared including a 7.5 wt % glycidyl methacrylate modified |
| resin 2 | phenolic novolac resin, but no crosslinker. |
| Modified phenolic | Sample prepared including a 17 wt % glycidyl methacrylate modified |
| resin 3 | phenolic novolac resin, but no crosslinker. |
| Modified phenolic | Sample prepared including a 5 wt % glycidyl methacrylate modified |
| resin 1-M | phenolic novolac resin and melamine crosslinker. |
| Modified phenolic | Sample prepared including a 7.5 wt % glycidyl methacrylate modified |
| resin 2-M | phenolic novolac resin and melamine crosslinker. |
| Modified phenolic | Sample prepared including a 17 wt % glycidyl methacrylate modified |
| resin 3-M | novolac resin and melamine crosslinker. |

Various rubber samples were mixed according to the formulations shown in Table 2. Mixing was performed using a two-step mixing procedure in a BANBURY™ internal mixer followed by cross-blending on a two roller mill according to the mixing schedule shown in Table 3.

TABLE 2
Rubber formulation (loadings are shown in phr)

| | | | | | | | Modified | Modified | Modified |
|---|---|---|---|---|---|---|---|---|---|
| | | | | Modified | Modified | Modified | phenolic | phenolic | phenolic |
| | | | | phenolic | phenolic | phenolic | resin | resin | resin |
| | Ingredient | Blank | Control | resin 1 | resin 2 | resin 3 | 1-M | 2-M | 3-M |
| Pass | SMR 20 | 100.00 | 100.00 | 100.00 | 100.00 | 100.00 | 100.00 | 100.00 | 100.00 |
| 1 | Zinc oxide | 3.50 | 3.50 | 3.50 | 3.50 | 3.50 | 3.50 | 3.50 | 3.50 |
| | Stearic acid | 3.00 | 3.00 | 3.00 | 3.00 | 3.00 | 3.00 | 3.00 | 3.00 |
| | Carbon | 22.50 | 22.50 | 22.50 | 22.50 | 22.50 | 22.50 | 22.50 | 22.50 |
| | black, N375 | | | | | | | | |
| | Carbon | 22.50 | 22.50 | 22.50 | 22.50 | 22.50 | 22.50 | 22.50 | 22.50 |
| | black, N660 | | | | | | | | |
| | Antiozonant, | 1.20 | 1.20 | 1.20 | 1.20 | 1.20 | 1.20 | 1.20 | 1.20 |
| | 6PPD | | | | | | | | |
| | Antioxidant, | 0.50 | 0.50 | 0.50 | 0.50 | 0.50 | 0.50 | 0.50 | 0.50 |
| | TMQ (RD) | | | | | | | | |
| | HRJ-12952 | — | 10.00 | — | — | — | — | — | — |
| | Modified | — | — | 10.00 | — | — | 10.00 | — | — |
| | phenolic | | | | | | | | |
| | resin 1 | | | | | | | | |
| | Modified | — | — | — | 10.00 | — | — | 10.00 | — |
| | phenolic | | | | | | | | |
| | resin 2 | | | | | | | | |
| | Modified | — | — | — | — | 10.00 | — | — | 10.00 |
| | phenolic | | | | | | | | |
| | resin 3 | | | | | | | | |
| Pass | Insoluble | 1.70 | 1.70 | 1.70 | 1.70 | 1.70 | 1.70 | 1.70 | 1.70 |
| 2 | sulfur | | | | | | | | |
| | Accelerator, | 1.40 | 1.40 | 1.40 | 1.40 | 1.40 | 1.40 | 1.40 | 1.40 |
| | TBBS | | | | | | | | |
| | HMMM | — | 1.30 | — | — | — | — | — | — |
| | Melamine | — | — | — | — | — | 0.17 | 0.26 | 0.60 |
| | TOTALS | 156.30 | 167.60 | 166.30 | 166.30 | 166.30 | 166.47 | 166.56 | 166.90 |

As shown in Table 2, for the samples containing a modified or non-modified novolac resin, the resin was mixed into the rubber compound at 10.00 phr at Pass 1. For each sample, the cure package contained insoluble sulfur (1.7 phr) and TBBS sulfur accelerator (1.4 phr) was mixed into the rubber compound at Pass 2. For the control sample containing HRJ-12952 resin, the cure package also contained HMMM crosslinker (1.3 phr). Each of the modified phenol novolac resins were tested with and without melamine crosslinker. For the glycidyl methacrylate modified resin samples containing melamine crosslinker, melamine was added to the cure package at an amount in excess to the stoichiometric amount, with 15 wt % in excess based on the loading amount of glycidyl methacrylate.

### Rubber Sample Preparation Via BANBURY™ Mixer Mixing

For each sample shown in Table 1, the procedure below was followed to prepare the individual rubber compounds. The loading amounts for other ingredients in the rubber formulation are shown in Table 2.

First, the rotors and mixing chamber were set to 60° C. The rotors were turned on to 60 rpm and the ram was moved to upper position. Raw SMR 20 elastomer was loaded and mixed for 30 seconds. Then the pass 1 chemicals and resin (as shown in Table 2) were added to the mixer and allowed to mix for 4 minutes. The batch was then dropped to the collection bin.

Following pass 1 BANBURY™ mixer mixing, each rubber sample was further mixed on a two-roller mill according to the following procedure. A two-roller mill was pre-heated to 115° F. (approximately 46° C.) and the nip was set to 0 degrees. The mill rollers were started at 18 rpm. The rubber sample was then placed between the two rollers and the rubber passed through the mill and banded onto the front roller. The rubber on the front roller was cut multiple times: a first cut was made right-to-left and the rubber was stretched off the roller and then fed back in; a second cut was made left-to-right followed by stretching and re-feeding the material back onto the mill. This cutting process was repeated continuously over an eight-minute period. The rubber was then sheeted at a nip setting of 0 degrees and allowed to cool overnight.

Pass 2 mixing was accomplished according to the following procedure. The BANBURY™ mixer rotors and mixing chamber were set to 60° C. The rotors were turned on to 50 rpm and the ram was moved to upper position. The masterbatch rubber prepared in pass 1 was loaded to the mixing chamber, the ram was lowered, and the material was allowed to mix for 30 seconds. Afterwards, the ram was raised and the cure package was loaded to the mixer. The ram was lowered and the cure package was mixed for two minutes, after which the batch was then dropped to the collection bin. Each sample was then milled at a nip setting of 0 degrees for a total of 4 minutes with constant cross-blending at a temperature of 115° F. as outlined for pass 1 mixing. The rubber samples were sheeted off the mill at a final nip setting of 35-40 degrees to provide a sheet thickness of approximately 2-3 mm.

The mixing procedures are also summarized in the following Table 3.

TABLE 3
Mixing procedure for shoulder compound containing novolac resin

| | | | Time | Temp | RPM |
|---|---|---|---|---|---|
| Shoulder | Step [#] | Step Description | [seconds] | [Celsius] | [1/min] |
| Pass 1 | 1 | Load elastomer (SIR20) | — | 60 | 60 |
| | 2 | Mix for 30 seconds | 30 | — | 60 |
| | 3 | Load ZnO, stearic acid, carbon | — | 140 max | 60 |
| | | black, 6PPD, TMQ, and resin | | | |
| | 4 | Mix for 4 minutes | 240 | | 60 |
| | 7 | Drop batch | — | | 60 |
| Pass 1 | Mill for 8 minutes with cross-blending at nip setting of 0 and a temperature of 115° F. | | | | |
| Milling | | | | | |
| Pass 2 | 1 | Load masterbatch from pass 1 | — | 60 | 50 |
| | 2 | Mix for 30 seconds | 30 | Max | 50 |
| | 3 | Load cure packing | — | 120° C. | 50 |
| | 4 | Mix for 2 minutes | 120 | | 50 |
| | 5 | Drop batch | | | 50 |

| | |
|---|---|
| Pass 2 | Mill for 4 minutes with cross-blending at nip setting of 0 and a temperature of 115° F. |
| Milling | Sheet off at nip setting of 35-40 and a temperature of 115° F. |

### RPA Sample Preparation

To obtain cure data, 32 mm diameter samples (approximately 5 g and 2.5 mm thickness) were run on a TA Instruments RPA Auto Elite with autosampler.

### RPA: MDR 160° C. Test Procedure

Samples were autoloaded between two mylar film sheets onto the lower RPA Auto Elite die. A 160° C. test process was followed to determine cure time and torque. The sample was heated to 160° C. for 30 minutes at 1.67 Hz, 6.98% strain to yield cure data, such as T90, which was used to cure samples for other tests.

### Mixing Viscosity

The results of the mixing viscosity of each sample are shown in FIG. 1. The complex viscosity (n*) was characterized by pre-cure strain sweep at 100° C., 1.0 Hz, and was plotted as a function of strain angle.

FIG. 1 shows that the mixing viscosities of the rubber samples prepared with the modified phenol novolac resins was similar to or lower than the mixing viscosity for the rubber sample prepared with the unmodified phenol novolac resin (control resin). In some samples, the mixing viscosities of the rubber samples prepared with the modified phenol novolac resins (Modified phenolic resins 1 and 3) were about 13% lower than the mixing viscosity for the rubber sample prepared with the unmodified phenol novolac resin (control resin).

### Cure Characteristics

The rubber samples containing blank and control resins were cured at 160° C. for 30 minutes at 1.67 Hz, 6.98% strain, and the rubber samples containing modified novolac resins were cured at 150° C. for 30 minutes at 1.67 Hz, 6.98% strain.

The curing temperature for the rubber samples containing modified novolac resins was chosen to be 150° C., as the rubber samples containing modified novolac resins were more stable at 150° C. than at 160° C.

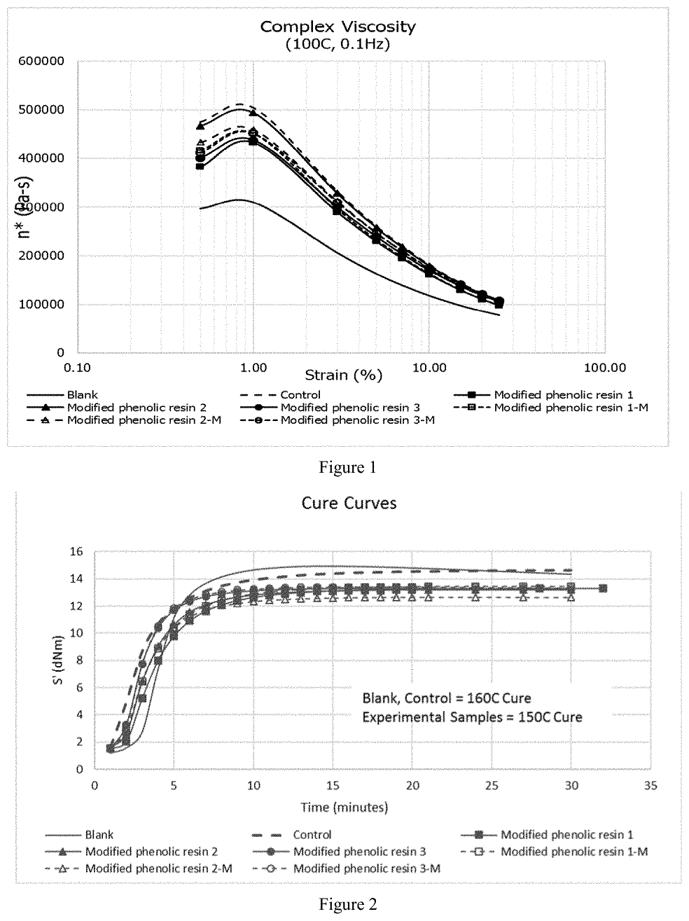

Curing curves for all samples were plotted as a function of time as shown in FIG. 2. FIG. 2 shows that each rubber sample exhibited similar cure properties. The rubber samples containing the unmodified resin (control resin) with HMMM crosslinker exhibited a slightly higher crosslink density than the rubber samples containing the modified novolac resins, both with and without melamine crosslinker.

Table 4 below shows that increasing the amount of glycidyl methacrylate modification on the modified novolac resin resulted in a decrease in cure time of the rubber compound that each resin was added to. This indicates that a curing process has taken place for the modified resins and was a direct result of the modification.

TABLE 4
Trend in resin modification content and cure time

| | Wt % | Tc90 |
|---|---|---|
| | modification | (90% of cure time) |
| Blank | 0.0 | 6.81 |
| Control | 0.0 | 7.47 |
| Modified phenolic resin 1 | 5.0 | 8.00 |
| Modified phenolic resin 2 | 7.5 | 6.82 |
| Modified phenolic resin 3 | 17.0 | 5.53 |
| Modified phenolic resin 1-M | 5.0 | 7.51 |
| Modified phenolic resin 2-M | 7.5 | 6.61 |
| Modified phenolic resin 3-M | 17.0 | 5.47 |

Collectively, the data demonstrates that without the use of a conventional HMMM crosslinker with a phenolic resin in a cure package in a rubber compound, the rubber compound with a cure packaging containing a phenolic resin modified by the ethylenically unsaturated carboxylate compound provides similar curing properties.

### Tensile Properties

Milled rubber sheet prepared during the second pass of the mixing process was used to prepare a 150 mm×150 mm cured rubber sheet of approximately 2.5 mm thickness. Samples were cured based on T90+4 minutes. After tensile plaques were cured, they were removed from the curing mold and allowed to cool to room temperature overnight. An ISO 37, Type 2 die was used to cut test specimens from the cured tensile plaques for testing.

Samples were tested using ISO 37 and an INSTRON™ model 5965 universal tensile testing machine (aka Instron) with a 5 kN load cell to displace the samples for stress/strain calculations.

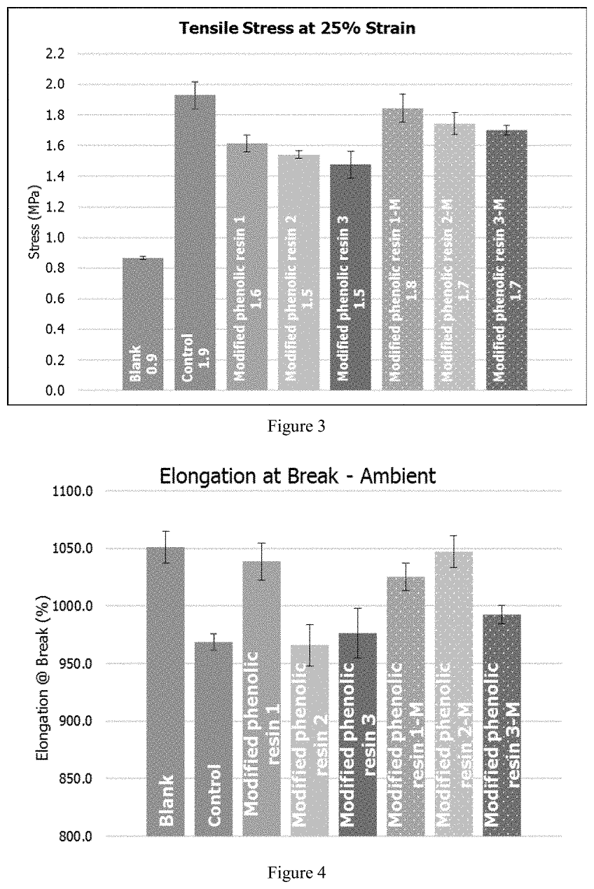

The results of the tensile stresses at 25% strain for the rubber samples are shown in FIG. 3. The tensile stresses of the rubber samples containing glycidyl-methacrylate-modified phenolic resins were slightly lower as compared to the control sample. The large increase in tensile stress at 25% strain for the rubber samples containing modified resin as compared to the blank indicates the chemical reinforcement of these rubber samples by the modified novolac resin.

Moreover, the addition of melamine crosslinker to the rubber sample containing the modified novolac resins (modified phenolic resins 1-M to 3-M) resulted in an improvement in tensile strength over rubber samples containing the modified novolac resins, but with no melamine crosslinker (modified phenolic resins 1 to 3).

The tensile test also showed that there was an inverse relationship between the tensile stress at 25% strain and the amount of glycidyl methacrylate modification on the modified novolac resin loaded into the rubber samples, for the rubber samples both with and without melamine crosslinker, indicating the reduction in chemical reinforcement with an increase in modification content. Among these tested samples, the rubber sample containing the novolac resin modified by 5 wt % glycidyl methacrylate and with melamine was shown to have statistically equivalent tensile strength as the control sample. These data also suggest that a lower amount of glycidyl methacrylate modification on the novolac resin provides sufficient tensile strength.

The results of the tensile elongations at break at ambient for the rubber samples are shown in FIG. 4. The elongations of the rubber samples prepared with the modified phenol novolac resins was comparable to or significantly improved than the elongation at break for the rubber sample prepared with the unmodified phenol novolac resin (control resin). In some samples, the elongation at break of the rubber samples prepared with the modified phenol novolac resin showed about 7% increase (modified phenolic resin 1) compared to the elongation at break for the rubber sample prepared with the unmodified phenol novolac resin (control resin).

Moreover, all the rubber samples containing the modified novolac resins with melamine crosslinker (modified phenolic resins 1-M to 3-M) have shown an increase in elongation at break compared to the unmodified phenol novolac resin (control resin).

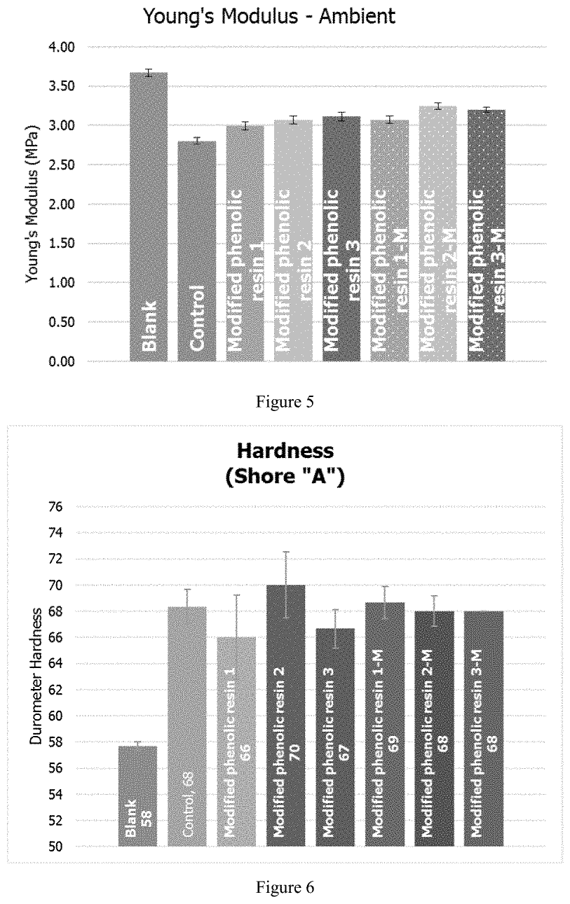

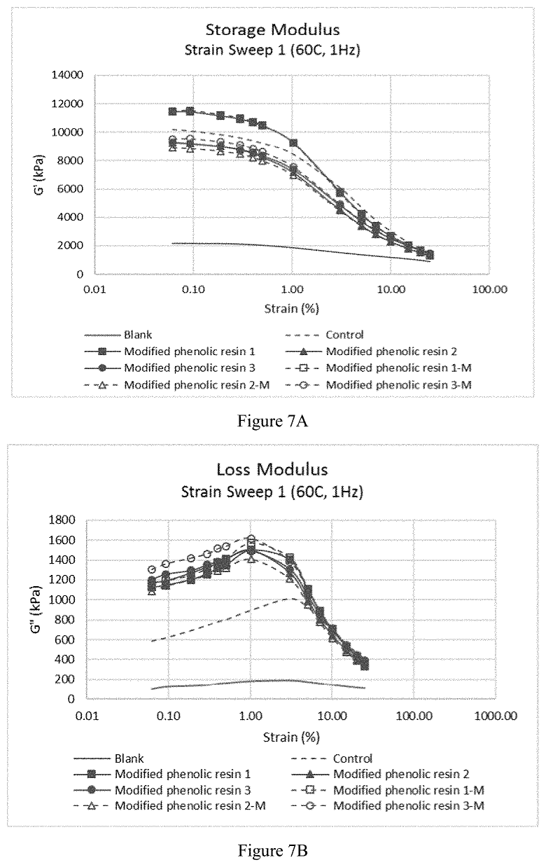

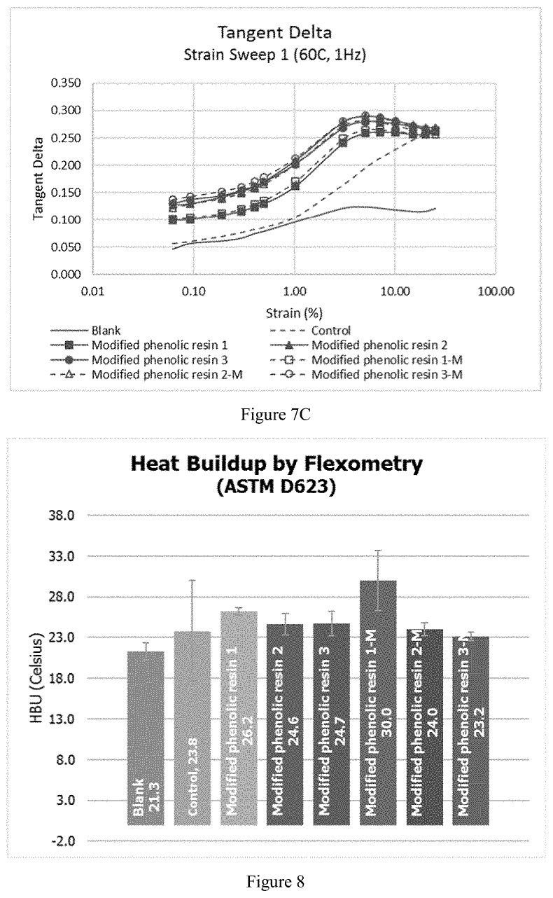

The results of the tensile stiffness (characterized by Young's modulus E at ambient condition) for the rubber samples are shown in FIG. 5. The elongations of the rubber samples prepared with the modified phenol novolac resins was comparable to or significantly improved than the elongation at break for the rubber sample prepared with the unmodified phenol novolac resin (control resin). In some samples, the elongation at break of the rubber samples prepared with the modified phenol novolac resin showed about 7% increase (modified phenolic resin 1) compared to the elongation at break for the rubber sample prepared with the unmodified phenol novolac resin (control resin).

All the rubber samples containing the modified novolac resins, both without (modified phenolic resins 1 to 3) or with melamine crosslinker (modified phenolic resins 1-M to 3-M) have shown an increase in Young's modulus E for at least about 7%, compared to the unmodified phenol novolac resin (control resin).

### Durometer Hardness

Hardness of cured rubber samples was determined by following the ASTM D2240 standard. To determine the hardness of the flexometer samples, the sample was placed flat side down and the anvil was dropped on the top, flat side. To determine the hardness of the tensile samples, two samples were placed on top of each other and the anvil was dropped on the middle of the cross-sectional area.

The results of the durometer hardness for the rubber samples are shown in FIG. 6. The hardness of all the rubber samples prepared with the modified phenol novolac resins was comparable to that of the durometer hardness for the rubber sample prepared with the unmodified phenol novolac resin (control resin). The large increase in hardness for the rubber samples containing modified phenolic resins (˜70) as compared to the blank (58) shows that the modified phenolic resins imparted hardness to the rubber compound, indicating the chemical reinforcement of these rubber samples by the modified novolac resin.

### Dynamic Properties

Testing for dynamic properties of the rubber samples was performed on a rubber process analyzer (TA Instruments RPA Auto Elite) at 60° C. and between 1-10 Hz after cure and was based on ASTM D6601. The blank sample containing no reinforcing resin and the control sample containing HRJ-12952 resin were cured between the dies of the RPA Auto Elite for 30 minutes at 160° C., followed by cooling to the test temperature and then subjected to 4 strain sweeps to determine the dynamic properties of the materials. The rubber samples containing the modified novolac resins were also run at the same test temperature using the same 4 strain sweep test, but were cured between the RPA dies at a temperature of 150° C. Samples produced G′ elastic response modulus (storage modulus), G″ viscous response modulus (loss modulus), and the ratio of elastic modulus over viscous modulus to arrive at the Tan D values. The results summarized in FIGS. 6A-6C were produced from the first strain sweep.

As shown in FIG. 6A, the rubber samples containing the novolac resins modified by 5 wt % glycidyl methacrylate, whether with melamine crosslinker (modified phenolic resin 1-M) or without melamine crosslinker (modified phenolic resin 1), both showed a similar increase in storage modulus (˜13%), as compared to the rubber sample containing the unmodified control resin. Both rubber samples showed almost equivalent G′ values regardless of whether melamine crosslinker was used or not. At greater than 5 wt % methacrylate modification on the novolac resin, the G′ values of the rubber samples containing the modified resin appeared to be lower than the rubber sample containing the unmodified control resin. All rubber samples containing modified novolac resins for chemical reinforcement (modified phenolic resins 1 to 3 and modified phenolic resins 1-M to 3-M) provided higher stiffness to the rubber compound compared with the blank sample that did not contain a reinforcing resin.

FIG. 6B illustrates an increase in the loss modulus of the rubber compounds containing the modified novolac resins, as compared to the rubber compound containing the unmodified control resin. This resulted in higher tangent delta values for the rubber compounds containing the modified novolac resins, as compared to the rubber compound containing the unmodified control resin, as shown in FIG. 6C. The peak hysteresis for the rubber compounds containing the modified novolac resins was comparable to the rubber compound containing the unmodified control resin.

The lowest amount of glycidyl methacrylate modification (modified phenolic resin 1) resulted in the lowest Tan D value among the modified phenolic resins tested. The melamine crosslinker did not appear to have an effect on the Tan D or loss modulus of the rubber sample containing phenolic novolac resin modified by 5 wt % glycidyl methacrylate, which again suggests that a lower amount of glycidyl methacrylate modification on the novolac resin would result in minimum hysteresis increase to the rubber compound while providing sufficient chemical reinforcement without using a crosslinker.

### Heat Build-Up Measured by a Flexometer

The rubber sheet that was prepared after pass 2 of the mixing process was used to make flexometer ASTM D623 samples. Samples for testing were made using a CCSI cutting die approximately 25 mm in height and 17 mm in diameter, a CCSI triplate 8 cavity mold with cavities 25 mm in height, 17 mm in diameter. The samples were pressed in a heated hydraulic press according to T90+10 min specifications. Before placing samples in the mold, the heated press and mold were heated to the predetermined curing temperature (160° C. for blank and control samples, 150° C. for functionalized resin samples). The 17 mm cutting die was used to punch three separate pieces from the rubber sheet prepared after pass 2 mixing that was folded in half. The punched out rubber was used to fill the 25 mm cavity in the triplate mold. Each of the three individual punches were packed into the mold cavity, a piece of foil was placed on top, and the top of the triplate was assembled to the mold. The samples were then cured for a time of T90+10 minutes. The mold was then removed from the press, and the samples were removed from the mold cavities and allowed to cool to room temperature.

Samples for heat generation were tested based on ASTM D623 with some slight modifications, as noted below. The test was run on EKT-2002GF (aka Ektron). The weight of 160N and a frequency of 33 Hz were used. The permanent (flex fatigue) set calculations were also based on ASTM D623 specifications, using a micrometer.

The results of heat build-up (HBU) from a series of 3 runs were averaged and summarized in FIG. 8. As shown in FIG. 8, the heat build-up of the rubber compounds containing modified phenolic novolac resin at all modification amounts tested was statistically similar to the heat build-up of the rubber compound containing the unmodified control resin.

### Example 2B: Rubber Formulation Using an Exemplary Modified Phenolic Resin

In this example, the phenolic resins modified by the ethylenically unsaturated carboxylate compound, were prepared according to Example 1B.

### Rubber Mixing

A rubber compound formulated for the shoulder of a tire was used for performance application testing of the rubber containing the functionalized glycidyl methacrylate phenol-formaldehyde resins.

The following samples listed in Table 5 were tested for the performance application testing. A commercially available reinforcing resin (SI Group HRJ-12952) was used as the phenol novolac resin in the Control sample given in Table 5. Glycidyl methacrylate was used for modifying phenol novolac resins, according to Example 1B, with the amounts of glycidyl methacrylate used in Example 1B at 2 wt %. Modified phenolic resin 4 does not contain a crosslinker.

TABLE 5
Shoulder formulation sample descriptions

| Sample | Description |
|---|---|
| Blank | Sample prepared without a phenolic novolac resin, and without acrosslinker. |
| Control | Sample prepared including a phenolic novolac resin (SI Group HRJ-12952) |
| | and HMMM crosslinker. |
| Modified phenolic | Sample prepared according to Example 1B, including a 2 wt % |
| resin 4 | glycidyl methacrylate modified phenolic novolac resin, but no |
| | crosslinker. |

Rubber samples were mixed according to the formulations shown in Table 6. Mixing was performed using a two-step mixing procedure in a BANBURY™ internal mixer followed by cross-blending on a two roller mill according to the mixing schedule shown in Table 3.

TABLE 6
Rubber formulation (loadings are shown in phr)

| | | | | Modified |
|---|---|---|---|---|
| | | | | Phenolic |
| | Ingredient | Blank | Control | Resin 4 |
| Pass 1 | SIR 20 | 100.0 | 100.0 | 100.0 |
| | Zinc Oxide RGT-M | 3.5 | 3.5 | 3.5 |
| | Stearic Acid RG Bead Form 66465 | 3.0 | 3.0 | 3.0 |
| | Carbon black, N375 | 22.5 | 22.5 | 22.5 |
| | Carbon Black, N660 (Sterling V) | 22.5 | 22.5 | 22.5 |
| | PD-2 Pellets (6PPD) | 1.2 | 1.2 | 1.2 |
| | Antioxidant DQ Powder 03625 | 0.45 | 0.5 | 0.5 |
| | HRJ-12952 | | 10.0 | |
| | Modified Phenolic Resin I | | | 10.2 |
| Pass 2 | IS-70/SBR/P | 1.7 | 1.7 | 1.7 |
| | BBTS Powder | 1.4 | 1.4 | 1.4 |
| | HMMM, Cyrez CRA 200-s | | 1.3 | |
| | TOTALS | 156.29 | 167.7 | 166.5 |

As shown in Table 6, the control resin, HRJ-12952, and the modified phenol novolac resin were loaded into separate rubber compounds at a target concentration of 10 phr. For each sample, the cure package contained insoluble sulfur (1.7 phr) and TBBS sulfur accelerator (1.4 phr) was mixed into the rubber compound at Pass 2. For the control sample containing HRJ-12952 resin, the cure package also contained HMMM crosslinker (1.3 phr). The modified phenolic resin 4 did not include a crosslinker.

### Rubber Sample Preparation Via BANBURY™ Mixer Mixing

For each sample shown in Table 5, the procedure below was followed to prepare the individual rubber compounds. The loading amounts for other ingredients in the rubber formulation are shown in Table 6.

First, the rotors and mixing chamber were set to 60° C. The rotors were turned on to 60 rpm and the ram was moved to upper position. Raw SMR 20 elastomer was loaded and mixed for 30 seconds. Then the pass 1 chemicals and resin (as shown in Table 6) were added to the mixer and allowed to mix for 4 minutes. The batch was then dropped to the collection bin.

Following pass 1 BANBURY™ mixer mixing, each rubber sample was further mixed on a two-roller mill according to the following procedure. A two-roller mill was pre-heated to 115° F. (approximately 46° C.) and the nip was set to 0 degrees. The mill rollers were started at 18 rpm. The rubber sample was then placed between the two rollers and the rubber passed through the mill and banded onto the front roller. The rubber on the front roller was cut multiple times: a first cut was made right-to-left and the rubber was stretched off the roller and then fed back in; a second cut was made left-to-right followed by stretching and re-feeding the material back onto the mill. This cutting process was repeated continuously over an eight-minute period. The rubber was then sheeted at a nip setting of 0 degrees and allowed to cool overnight.

Pass 2 mixing was accomplished according to the following procedure. The BANBURY™ mixer rotors and mixing chamber were set to 60° C. The rotors were turned on to 50 rpm and the ram was moved to upper position. The masterbatch rubber prepared in pass 1 was loaded to the mixing chamber, the ram was lowered, and the material was allowed to mix for 30 seconds. Afterwards, the ram was raised and the cure package was loaded to the mixer. The ram was lowered and the cure package was mixed for two minutes, after which the batch was then dropped to the collection bin. Each sample was then milled at a nip setting of 0 degrees for a total of 4 minutes with constant cross-blending at a temperature of 115° F. as outlined for pass 1 mixing. The rubber samples were sheeted off the mill at a final nip setting of 35-40 degrees to provide a sheet thickness of approximately 2-3 mm.

The summarization of the mixing procedures are the same as Table 3 in Example 2A.

### RPA Sample Preparation

To obtain cure data, 32 mm diameter samples (approximately 5 g and 2.5 mm thickness) were run on a TA Instruments RPA Auto Elite with autosampler.

### RPA: MDR 160° C. Test Procedure

Samples were autoloaded between two mylar film sheets onto the lower RPA Auto Elite die. A 160° C. test process was followed to determine cure time and torque. The sample was heated to 160° C. for 30 minutes at 1.67 Hz, 6.98% strain to yield cure data, such as T90, which was used to cure samples for other tests.

### Mixing Viscosity

The results of the mixing viscosity of each sample are shown in FIG. 9. The complex viscosity (n*) was characterized by pre-cure strain sweep at 100° C., 1.0 Hz, and was plotted as a function of strain.

FIG. 9 shows that the complex viscosity of the rubber sample prepared with the modified phenol novolac resin was similar to the mixing viscosity for the rubber sample prepared with the unmodified phenol novolac resin (control resin).

### Cure Characteristics

The rubber samples were cured at 160° C. for 30 minutes and torque changes were monitored at 6.98% strain at a frequency of 1.67 Hz.

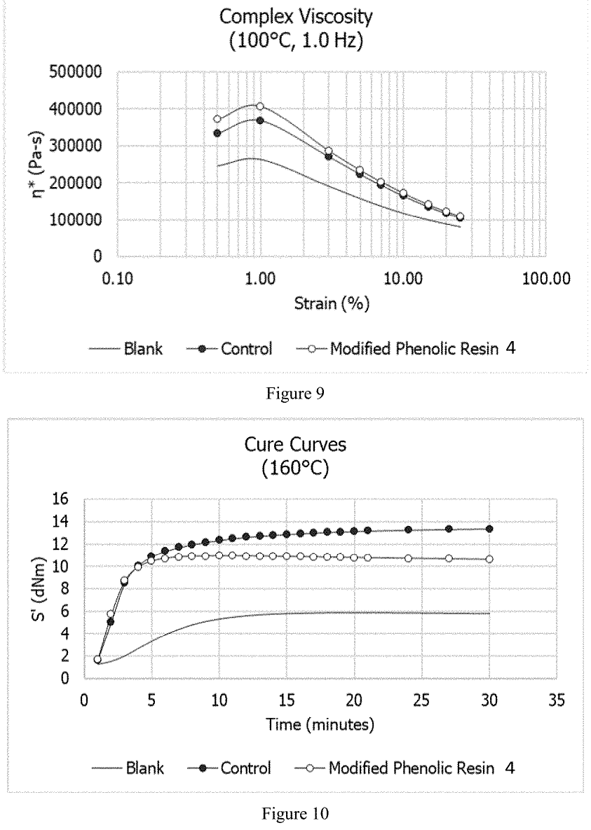

Curing curves for all rubber samples were plotted as a function of time as shown in FIG. 10. FIG. 10 shows that the control sample provided higher torque during curing than the modified phenolic resin sample, but similar increase in torque during the first 5 minutes of cure. This indicates a similar scorch value for the control sample and the sample containing the modified phenolic resin.

### Tensile Properties

Milled rubber sheet prepared during the second pass of the mixing process was used to prepare a 150 mm×150 mm cured rubber sheet of approximately 2.5 mm thickness. Samples were cured based on T90+4 minutes. After tensile plaques were cured, they were removed from the curing mold and allowed to cool to room temperature overnight. An ISO 37, Type 2 die was used to cut test specimens from the cured tensile plaques for testing.

Samples were tested using ISO 37 and an INSTRON™ model 5965 universal tensile testing machine (aka Instron) with a 5 kN load cell to displace the samples for stress/strain calculations.

The results of the tensile stress measurement at 25% strain for the rubber samples are shown in FIG. 11. The tensile stress of the rubber sample containing glycidyl methacrylate-modified phenolic resin was slightly lower as compared to the control sample. The large increase in tensile stress at 25% strain for the rubber sample containing modified resin as compared to the blank indicates the chemical reinforcement of these rubber samples by the modified phenolic resin.

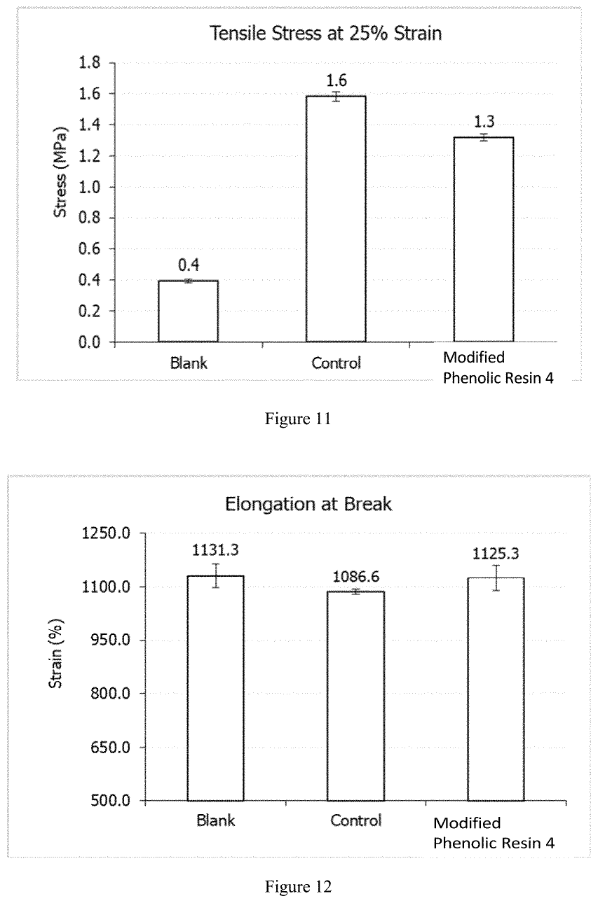

The results of the tensile elongations at break at ambient conditions for the rubber samples are shown in FIG. 12. The elongation of the rubber sample prepared with the modified phenolic novolac resin was slightly higher than the elongation at break for the rubber sample prepared with the unmodified phenolic novolac resin (control resin).

### Durometer Hardness

Hardness of cured rubber samples was determined by following the ASTM D2240 standard. To determine the hardness of the flexometer samples, the cylindrical sample was placed with one flat side down and the anvil was dropped on the top, flat side, after which a timer for 30 seconds was started. At the end of the 30 second time, the durometer reading was taken and reported as the hardness value for each sample.

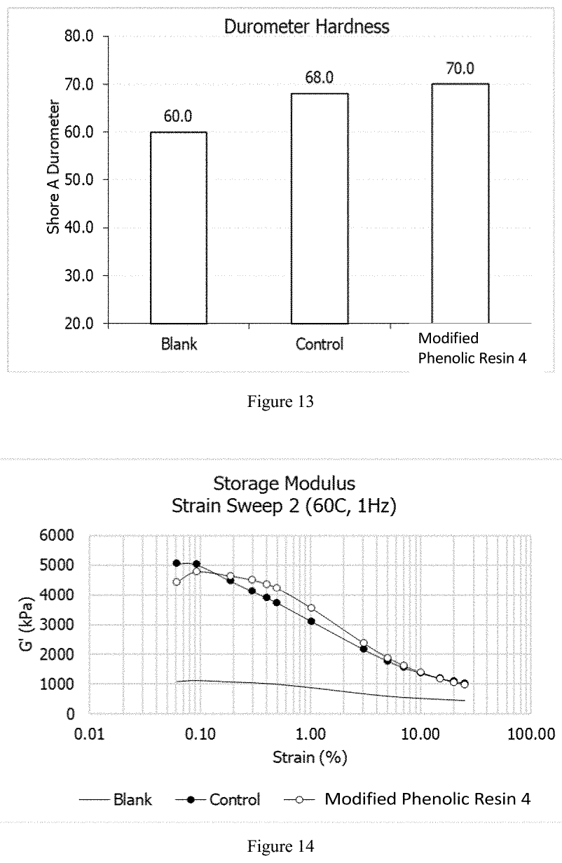

The results of the durometer hardness for the rubber samples are shown in FIG. 13. The hardness of all the rubber samples prepared with the modified phenol novolac resin was comparable to that of the durometer hardness for the rubber sample prepared with the unmodified phenol novolac resin (control resin). The large increase in hardness for the rubber samples containing modified phenolic resins (˜70) as compared to the blank (60) shows that the modified phenolic resins imparted hardness to the rubber compound, indicating that either a hardness imparted to the material by adding a modified or unmodified phenolic novolac resin, or chemical reinforcement of these rubber samples by the modified novolac resin or by the control resin.

### Dynamic Properties

Testing for dynamic properties of the rubber samples was performed on a rubber process analyzer (TA Instruments RPA Auto Elite) at 60° C. and between 1-10 Hz after cure and was based on ASTM D6601. The samples were cured between the dies of the RPA Auto Elite for 30 minutes at 160° C., followed by cooling to the test temperature and then subjected to 2 strain sweeps to determine the dynamic properties of the materials. Samples produced G′ elastic response modulus (storage modulus), G″ viscous response modulus (loss modulus), and the ratio of elastic modulus over viscous modulus to arrive at the Tan D values.

FIG. 14 shows the storage modulus, G′, of the experimental samples in the strain region of 0.05-25% strain for the second strain sweep performed, once the Mullin's Effect has been removed from the rubber samples. As shown in FIG. 14, the rubber sample containing the phenolic novolac resins modified by glycidyl methacrylate provided an equivalent storage modulus to the rubber sample containing the unmodified control resin.

### Example 2C: Rubber Formulation Using an Exemplary Modified Phenolic Resin

In this example, the phenolic resins modified by the ethylenically unsaturated carboxylate compound, were as prepared according to Example 1C.

### Rubber Mixing

A rubber compound formulated for the shoulder of a tire was used for performance application testing of the rubber containing the functionalized glycidyl methacrylate phenol-formaldehyde resins.

The following samples listed in Table 7 were tested for the performance application testing. A commercially available reinforcing resin (SI Group HRJ-12952) was used as the phenol novolac resin in the Control sample given in Table 7. Glycidyl methacrylate was used for modifying phenol novolac resins, according to Example 1C, with the amounts of glycidyl methacrylate used in Example 1C at 3 wt %. Modified phenolic resin 5 does not contain a crosslinker.

TABLE 7
Shoulder formulation sample descriptions

| Sample | Description |
|---|---|
| Blank | Sample prepared without a phenolic novolac resin, and without a crosslinker. |
| Control | Sample prepared including a phenolic novolac resin (SI Group HRJ-12952) |
| | and HMMM crosslinker. |
| Modified phenolic | Sample prepared according to Example 1C, including a 3 wt % |
| resin 5 | glycidyl methacrylate modified phenolic novolac resin, but no |
| | crosslinker. |

Rubber samples were mixed according to the formulations shown in Table 7. Mixing was performed using a two-step mixing procedure in a BANBURY™ internal mixer followed by cross-blending on a two roller mill according to the mixing schedule shown in Table 3.

TABLE 8
Rubber formulation (loadings are shown in phr)

| | | | | Modified |
|---|---|---|---|---|
| | Ingredient | Blank | Control | Phenolic Resin 4 |
| Pass 1 | SIR 20 | 100.0 | 100.0 | 100.0 |
| | Zinc Oxide RGT-M | 3.5 | 3.5 | 3.5 |
| | Stearic Acid RG Bead Form | 3.0 | 3.0 | 3.0 |
| | 66465 | | | |
| | Carbon black, N375 | 22.6 | 22.4 | 22.5 |
| | Carbon Black, N660 (Sterling V) | 22.6 | 22.4 | 22.5 |
| | PD-2 Pellets (6PPD) | 1.1 | 1.2 | 1.2 |
| | Antioxidant DQ Powder 03625 | 0.5 | 0.5 | 0.5 |
| | HRJ-12952 | | 10.0 | |
| | Modified Phenolic Resin I | | | 10.0 |
| Pass 2 | IS-70/SBR/P | 1.7 | 1.7 | 1.70 |
| | BBTS Powder | 1.4 | 1.4 | 1.4 |
| | HMMM, Cyrez CRA 200-s | | 1.3 | |
| | TOTALS | 156.7 | 167.4 | 166.4 |

As shown in Table 8, the control resin, HRJ-12952, and the modified phenol novolac resin were loaded into separate rubber compounds at a target concentration of 10 phr. For each sample, the cure package contained insoluble sulfur (˜1.7 phr) and TBBS sulfur accelerator (˜1.4 phr) was mixed into the rubber compound at Pass 2. For the control sample containing HRJ-12952 resin, the cure package also contained HMMM crosslinker (1.3 phr). The modified phenolic resin 5 did not include a crosslinker.

### Rubber Sample Preparation Via BANBURY™ Mixer Mixing

For each sample shown in Table 7, the procedure below was followed to prepare the individual rubber compounds. The loading amounts for other ingredients in the rubber formulation are shown in Table 8.

First, the rotors and mixing chamber were set to 60° C. The rotors were turned on to 60 rpm and the ram was moved to upper position. Raw SMR 20 elastomer was loaded and mixed for 30 seconds. Then the pass 1 chemicals and resin (as shown in Table 8) were added to the mixer and allowed to mix for 4 minutes. The batch was then dropped to the collection bin.

Following pass 1 BANBURY™ mixer mixing, each rubber sample was further mixed on a two-roller mill according to the following procedure. A two-roller mill was pre-heated to 115° F. (approximately 46° C.) and the nip was set to 0 degrees. The mill rollers were started at 18 rpm. The rubber sample was then placed between the two rollers and the rubber passed through the mill and banded onto the front roller. The rubber on the front roller was cut multiple times: a first cut was made right-to-left and the rubber was stretched off the roller and then fed back in; a second cut was made left-to-right followed by stretching and re-feeding the material back onto the mill. This cutting process was repeated continuously over an eight-minute period. The rubber was then sheeted at a nip setting of 0 degrees and allowed to cool overnight.

Pass 2 mixing was accomplished according to the following procedure. The BANBURY™ mixer rotors and mixing chamber were set to 60° C. The rotors were turned on to 50 rpm and the ram was moved to upper position. The masterbatch rubber prepared in pass 1 was loaded to the mixing chamber, the ram was lowered, and the material was allowed to mix for 30 seconds. Afterwards, the ram was raised and the cure package was loaded to the mixer. The ram was lowered and the cure package was mixed for two minutes, after which the batch was then dropped to the collection bin. Each sample was then milled at a nip setting of 0 degrees for a total of 4 minutes with constant cross-blending at a temperature of 115° F. as outlined for pass 1 mixing. The rubber samples were sheeted off the mill at a final nip setting of 35-40 degrees to provide a sheet thickness of approximately 2-3 mm.

The summarization of the mixing procedures are the same as Table 3 in Example 2A.

### RPA Sample Preparation

To obtain cure data, 32 mm diameter samples (approximately 5 g and 2.5 mm thickness) were run on a TA Instruments RPA Auto Elite with autosampler.

### RPA: MDR 160° C. Test Procedure

Samples were autoloaded between two mylar film sheets onto the lower RPA Auto Elite die. A 160° C. test process was followed to determine cure time and torque. The sample was heated to 160° C. for 30 minutes at 1.67 Hz, 6.98% strain to yield cure data, such as Tc 90 and Ts 5, which was used to cure samples for other tests.

### Mixing Viscosity

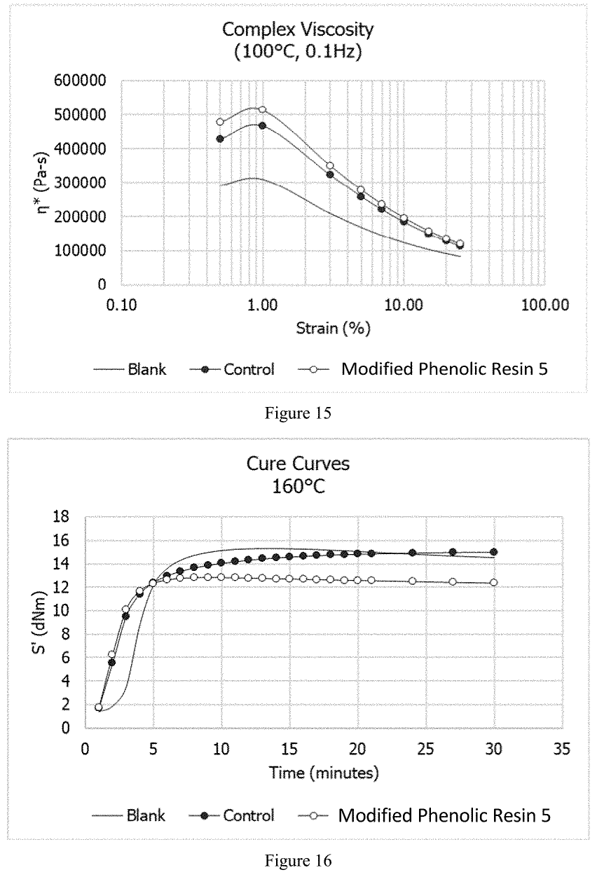

The results of the mixing viscosity of each sample are shown in FIG. 15. The complex viscosity (n*) was characterized by pre-cure strain sweep at 100° C., 1.0 Hz, and was plotted as a function of strain.

FIG. 15 shows that the complex viscosity of the rubber sample prepared with the modified phenolic novolac resin was similar to, or slightly higher than, the mixing viscosity for the rubber sample prepared with the unmodified phenol novolac resin (control resin) and was dependent on strain. At lower strain values, complex viscosity for the modified phenolic resin was higher than that of the control sample, while at higher strains, above approximately 10%, complex viscosity values for the two samples were more similar.

### Cure Characteristics

The rubber samples in this example were cured at 160° C. for 30 minutes and torque changes were monitored at 6.98% strain at a frequency of 1.67 Hz.

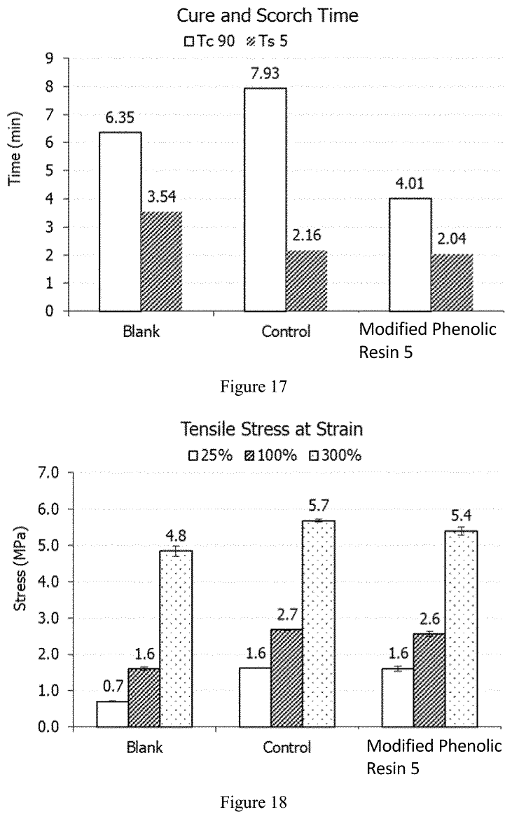

Curing curves for all samples were plotted as a function of time as shown in FIG. 16. FIG. 16 shows that the control sample provided higher torque during curing than the modified phenolic resin sample, but similar increase in torque during the first 5 minutes of cure. This indicates a similar scorch value for the control sample and the sample containing the modified phenolic resin as indicated in FIG. 17. FIG. 17 also shows that the cure time, Tc 90, of the modified phenolic resin had a cure time approximately 50% reduced compared to the control sample.

### Tensile Properties

Milled rubber sheet prepared during the second pass of the mixing process was used to prepare a 150 mm×150 mm cured rubber sheet of approximately 2.5 mm thickness. Samples were cured based on T90+4 minutes. After tensile plaques were cured, they were removed from the curing mold and allowed to cool to room temperature overnight. An ISO 37, Type 2 die was used to cut test specimens from the cured tensile plaques for testing.

Samples were tested using ISO 37 and an INSTRON™ model 5965 universal tensile testing machine (aka Instron) with a 5 kN load cell to displace the samples for stress/strain calculations.

The results of the tensile stress measurement at 25%, 100%, and 300% strain for the rubber samples are shown in FIG. 18. The tensile stress of the rubber sample containing glycidyl-methacrylate-modified phenolic resin was statistically equivalent to the control sample at 25% and 100% strain. At 300% strain, the control sample was shown to have a slightly higher tensile stress than the modified phenolic resin. The large increase in tensile stress at 25% strain for the rubber sample containing modified resin as compared to the blank indicates the chemical reinforcement of these rubber samples by the modified novolac resin. Higher strain tensile stresses that were similar to each other indicate comparable stiffness in the 100-300% strain region.

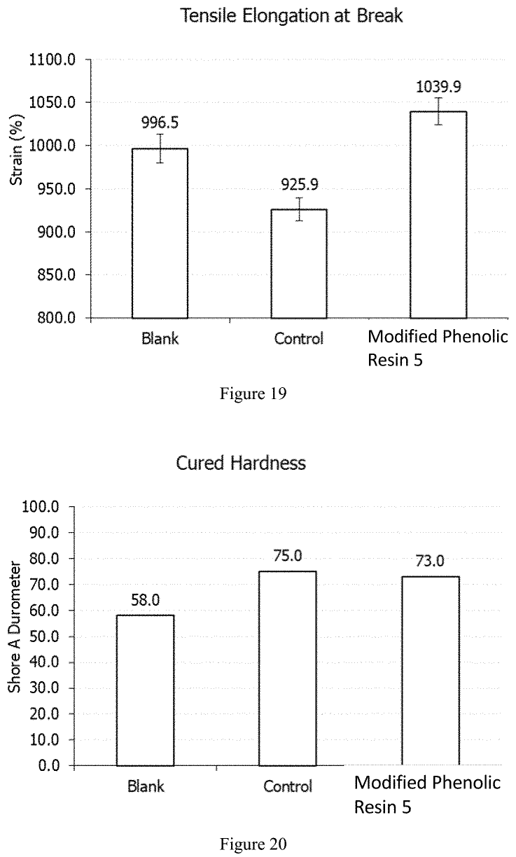

The results of the tensile elongations at break at ambient for the rubber samples are shown in FIG. 19. The elongation of the rubber sample prepared with the modified phenol novolac resin was higher than the elongation at break for the rubber sample prepared with the unmodified phenol novolac resin (control resin).

### Durometer Hardness

Hardness of cured rubber samples was determined by following the ASTM D2240 standard. To determine the hardness of the flexometer samples, the cylindrical sample was placed with one flat side down and the anvil was dropped on the top, flat side, after which a timer for 30 seconds was started. At the end of the 30 second time, the durometer reading was taken and reported as the hardness value for each sample.

The results of the durometer hardness for the rubber samples are shown in FIG. 20. The hardness of all the rubber sample prepared with the modified phenol novolac resin was comparable to that of the durometer hardness for the rubber sample prepared with the unmodified phenol novolac resin (control resin). The large increase in hardness for the rubber samples containing modified phenolic resins as compared to the blank shows that the modified phenolic resins imparted hardness to the rubber compound, indicating the either a hardness imparted to the material by adding a modified or unmodified phenolic novolac resin, or chemical reinforcement of these rubber samples by the modified novolac resin or by the control resin.

### Dynamic Properties

Testing for dynamic properties of the rubber samples was performed on a rubber process analyzer (TA Instruments RPA Auto Elite) at 60° C. and between 1-10 Hz after cure and was based on ASTM D6601. The samples were cured between the dies of the RPA Auto Elite for 30 minutes at 160° C., followed by cooling to the test temperature and then subjected to 2 strain sweeps to determine the dynamic properties of the materials. Samples produced G′ elastic response modulus (storage modulus), G″ viscous response modulus (loss modulus), and the ratio of elastic modulus over viscous modulus to arrive at the Tan D values.

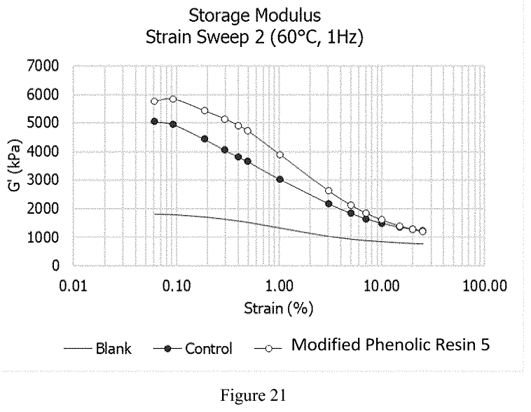

FIG. 21 shows the storage modulus, G′, of the experimental samples in the strain region of 0.05-25% strain for the second strain sweep performed, once the Mullin's Effect has been removed from the rubber samples. As shown in FIG. 21, the rubber sample containing the novolac resins modified by glycidyl methacrylate provide higher storage modulus from 0.05%—approximately 10% strain. Above 10% strain, the control resin sample and the modified phenolic resin provide similar storage modulus.

What is claimed is:

1. A modified phenolic resin comprising:
a phenolic resin modified by an ethylenically unsaturated carboxylate compound having the formula 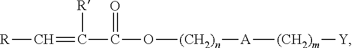
wherein:
Y is H or a functional group reactive to the hydroxyl phenyl or the benzene ring of the phenolic resin;
A is absent, a divalent form of ethene, a divalent form of C₃-C₁₂ cycloalkene, or a divalent form of arene;
R and R′ are each independently H or a C₁-C₈ alkyl; and
n and m are each independently an integer from 0-6;
wherein the ethylenically unsaturated carboxylate compound has affinity to or is chemically bonded to the hydroxyl phenyl or the benzene ring of the phenolic resin through the Y functional group.

2. The modified phenolic resin of claim 1, wherein Y is an epoxide group, a formyl group, or a halide.

3. The modified phenolic resin of claim 1, wherein:
A is absent, a divalent form of ethene, or a divalent form of benzene;
R and R′ are each independently H or methyl; and
n and m are each independently 0, 1, or 2.

4. The modified phenolic resin of claim 1, wherein the ethylenically unsaturated carboxylate compound is

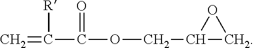

5. The modified phenolic resin of claim 4, wherein the ethylenically unsaturated carboxylate compound is glycidyl methacrylate or glycidyl acrylate.

6. The modified phenolic resin of claim 1, wherein the ethylenically unsaturated carboxylate compound is represented by one of the following formulas: 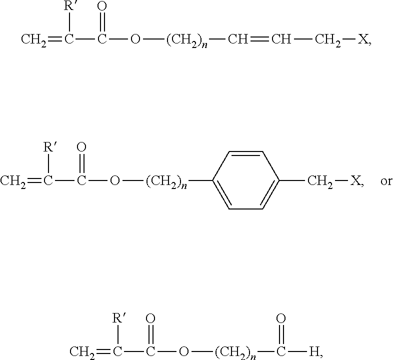
wherein n is 0, 1, or 2, and X is a halide.

7. The modified phenolic resin of claim 1, wherein the phenolic resin is a monohydric- or dihydric-phenolic-aldehyde resin, optionally modified by a naturally-derived organic compound containing at least one unsaturated bond.

8. The modified phenolic resin of claim 7, wherein the phenolic resin is a phenol-aldehyde resin, alkylphenol-aldehyde resin, resorcinol-aldehyde resin, or combinations thereof.

9. The modified phenolic resin of claim 1, wherein the amount of the ethylenically unsaturated carboxylate compound ranges from about 0.1 wt % to about 25 wt %, based on the amount of the phenolic resin.

10. The modified phenolic resin of claim 9, wherein the amount of the ethylenically unsaturated carboxylate compound ranges from about 0.5 wt % to about 5 wt %, based on the amount of the phenolic resin.

11. The modified phenolic resin of claim 1, wherein the modified phenolic resin is a single-component curing system that is self-crosslinkable or self-polymerizable by heating.

12. A process for preparing a modified phenolic resin, comprising:
reacting a phenolic compound, an aldehyde, and an ethylenically unsaturated carboxylate compound having the formula 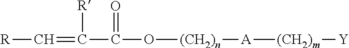
to form the modified phenolic resin,
wherein:
Y is H or a functional group reactive to the hydroxyl phenyl or the benzene ring of the phenolic resin;
A is absent, a divalent form of ethene, a divalent form of C₃-C₁₂ cycloalkene, or a divalent form of arene;
R and R′ are each independently H or a C₁-C₈ alkyl; and
n and m are each independently an integer from 0-6.

13. The process of claim 12, wherein the reacting step comprises:
reacting the phenolic compound and the aldehyde to form a phenolic resin, and
modifying the phenolic resin by chemically bonding the ethylenically unsaturated carboxylate compound to the hydroxyl phenyl or the benzene ring of the phenolic resin through the Y functional group.

14. A rubber composition, comprising:
(a) a rubber component comprising a natural rubber, a synthetic rubber, or a mixture thereof; and
(b) a modified phenolic resin component comprising: a phenolic resin modified by an ethylenically unsaturated carboxylate compound, wherein the ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin,
wherein the rubber composition does not contain a methylene donor cross-linking agent that decomposes to an aldehyde.

15. The rubber composition of claim 14, wherein the ethylenically unsaturated carboxylate compound has the formula: 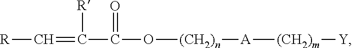
wherein:
A is absent, a divalent form of ethene, a divalent form of C₃-C₁₂ cycloalkene, or a divalent form of arene;
Y is H or a functional group reactive to the hydroxyl phenyl or the benzene ring of the phenolic resin;
R and R′ are each independently H or a C₁-C₈ alkyl; and
n and m are each independently an integer from 0-6;
wherein the ethylenically unsaturated carboxylate compound has affinity to or is chemically bonded to the hydroxyl phenyl or the benzene ring of the phenolic resin through the Y functional group.

16. The rubber composition of claim 15, wherein in the modified phenolic resin component, the ethylenically unsaturated carboxylate compound is

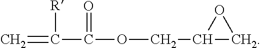

17. The rubber composition of claim 16, wherein the ethylenically unsaturated carboxylate compound is glycidyl methacrylate or glycidyl acrylate.

18. The rubber composition of claim 15, wherein in the modified phenolic resin component, the ethylenically unsaturated carboxylate compound is represented by one of the following formulas: 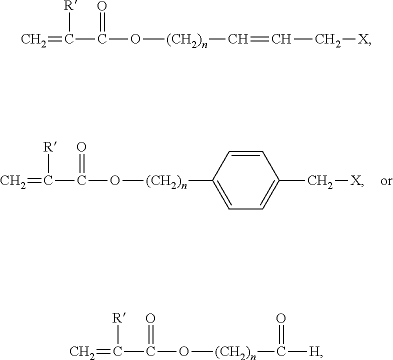
wherein n is 0, 1, or 2, and X is a halide.

19. The rubber composition of claim 14, wherein in the modified phenolic resin component, the phenolic resin is a monohydric- or dihydric-phenolic-aldehyde resin, optionally modified by a naturally-derived organic compound containing at least one unsaturated bond.

20. The rubber composition of claim 19, wherein the phenolic resin is a phenol-aldehyde resin, alkylphenol-aldehyde resin, resorcinol-aldehyde resin, or combinations thereof.

21. The rubber composition of claim 14, wherein in the modified phenolic resin component, the amount of the ethylenically unsaturated carboxylate compound ranges from about 0.1 wt % to about 25 wt %, based on the amount of the phenolic resin.

22. The rubber composition of claim 21, wherein the amount of the ethylenically unsaturated carboxylate compound ranges from about 0.5 wt % to about 5 wt %, based on the amount of the phenolic resin.

23. The rubber composition of claim 14, wherein the rubber composition does not contain hexamethylenetetramine (HMTA) or hexa(methoxymethyl)melamine (HMMM).

24. The rubber composition of claim 14, wherein the modified phenolic resin component in the rubber composition ranges from about 0.5 to about 50 parts per 100 parts rubber by weight.

25. A rubber product formed from the rubber composition of claim 14.

26. A formaldehyde-free process for preparing a rubber composition, comprising:
mixing (a) a rubber component comprising a natural rubber, a synthetic rubber, or a mixture thereof and (b) a modified phenolic resin component comprising: a phenolic resin modified by an ethylenically unsaturated carboxylate compound, wherein the ethylenically unsaturated carboxylate compound (i) contains a thermally polymerizable or crosslinkable functional group, and (ii) has affinity to or is chemically bonded to the hydroxyl phenyl or the benzene ring of the phenolic resin, thereby introducing the thermally polymerizable or crosslinkable functional group in the phenolic resin,
wherein the process does not emit formaldehyde.

27. The formaldehyde-free process of claim 26, wherein the ethylenically unsaturated carboxylate compound has the formula: 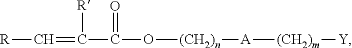
wherein:
A is absent, a divalent form of ethene, a divalent form of C₃-C₁₂ cycloalkene, or a divalent form of arene;
Y is H or a functional group reactive to the hydroxyl phenyl or the benzene ring of the phenolic resin;
R and R′ are each independently H or a C₁-C₈ alkyl; and
n and m are each independently an integer from 0-6;
wherein the ethylenically unsaturated carboxylate compound has affinity to or is chemically bonded to the hydroxyl phenyl or the benzene ring of the phenolic resin through the Y functional group.

28. The formaldehyde-free process of claim 27, further comprising:
curing (vulcanizing) the rubber composition at a curing temperature sufficient to induce polymerization or crosslinking of the modified phenolic resin.

29. The formaldehyde-free process of claim 27, wherein the modified phenolic resin component is a single-component curing system, and wherein the curing is carried out at a curing temperature sufficient to induce self-polymerizing or self-crosslinking of the modified phenolic resin.

30. The formaldehyde-free process of claim 26, wherein the process does not involve adding a methylene donor cross-linking agent.

31. The formaldehyde-free process of claim 30, wherein the process does not involve adding hexamethylenetetramine (HMTA) or hexa(methoxymethyl)melamine (HMMM).

32. The process of claim 12, wherein the reacting step comprises:
reacting the phenolic compound and the aldehyde to form a phenolic resin, and
modifying the phenolic resin by mixing a molten form of the phenolic resin with the ethylenically unsaturated carboxylate compound, wherein the ethylenically unsaturated carboxylate compound has affinity to the hydroxyl phenyl or the benzene ring of the phenolic resin through the Y functional group thereby introducing the thermally polymerizable or crosslinkable functional group in the phenolic resin.
